(19) United States
(12) Patent Application Publication
(10) Pub. No.: US 2008/0033944 A1
(43) Pub. Date: Feb. 7, 2008

(54) SYSTEMS AND METHODS FOR PRESENTING RESULTS OF GEOGRAPHIC TEXT SEARCHES

(75) Inventor: John R. FRANK, Cambridge, MA (US)

Correspondence Address: WILMERHALE/BOSTON, 60 STATE STREET, BOSTON, MA, 02109, US

(73) Assignee: METACARTA, INC., Cambridge, MA (US)

(21) Appl. No.: 11/834,538

(22) Filed: Aug. 6, 2007

Related U.S. Application Data
(60) Provisional application No. 60/835,690, filed on Aug. 4, 2006.

(51) Int. Cl. G06F 7/04

(52) U.S. Cl. 707/6; 707/E17.008

(57) ABSTRACT

Under one aspect, an interface program stored on a computer-readable medium causes a computer system to perform the functions of: accepting search criteria from a user, the search criteria including a free-text query and a domain identifier, the domain identifier identifying a domain in a metric vector space; in response to accepting the search criteria from the user, obtaining a set of document-location tuples from a corpus of documents, each document-location tuple satisfying the search criteria from the user, each location having associated cartographic display attributes; displaying a visual representation of the domain having an average spatial scale; selecting a subset of the set of document-location tuples based on the cartographic display attributes and on the average spatial scale of the visual representation of the domain; and displaying a plurality of visual indicators representing the selected subset of document-location tuples.

### CROSS REFERENCE TO RELATED APPLICATIONS

This application claims the benefit under 35 U.S.C. §119(e) of U.S. Provisional Application No. 60/835,690, filed Aug. 4, 2006 and entitled “Geographic Text Search Enhancements,” the entire contents of which are incorporated herein by reference.

This application is related to U.S. Pat. No. 7,117,199, issued Oct. 2, 2006 and entitled “Spatially Coding and Displaying Information,” the entire contents of which are incorporated herein by reference.

This application is also related to the following applications, filed concurrently herewith, the entire contents of which are incorporated herein by reference:

U.S. patent application Ser. No. (TBA), entitled “Systems and Methods for Presenting Results of Geographic Text Searches;”

U.S. patent application Ser. No. (TBA), entitled “Systems and Methods for Presenting Results of Geographic Text Searches;”

U.S. patent application Ser. No. (TBA), entitled “Systems and Methods for Presenting Results of Geographic Text Searches;”

U.S. patent application Ser. No. (TBA), entitled “Systems and Methods for Obtaining and Using Information from Map Images;”

U.S. patent application Ser. No. (TBA), entitled “Systems and Methods for Obtaining and Using Information from Map Images;” and

U.S. patent application Ser. No. (TBA), entitled “Systems and Methods for Obtaining and Using Information from Map Images.”

### TECHNICAL FIELD

This invention relates to computer systems, and more particularly to spatial databases, document databases, search engines, and data visualization.

### BACKGROUND

There are many tools available for organizing and accessing documents through different interfaces that help users find information. Some of these tools allow users to search for documents matching specific criteria, such as containing specified keywords. Some of these tools present information about geographic regions or spatial domains, such as driving directions presented on a map.

These tools are available on private computer systems and are sometimes made available over public networks, such as the Internet. Users can use these tools to gather information.

### SUMMARY OF THE INVENTION

The invention provides systems and methods for presenting results of geographic text search results.

Under one aspect, an interface program stored on a computer-readable medium causes a computer system with a display device to perform the functions of: accepting search criteria from a user, the search criteria including a free-text query and a domain identifier, the domain identifier identifying a domain in a metric vector space; in response to accepting the search criteria from the user, obtaining a set of document-location tuples from a corpus of documents, each document-location tuple satisfying the search criteria from the user, each location having associated cartographic display attributes; displaying on the display device a visual representation of the domain identified by the domain identifier, the visual representation of the domain having an average spatial scale; selecting a subset of the set of document-location tuples based on the cartographic display attributes and on the average spatial scale of the visual representation of the domain; and displaying a plurality of visual indicators representing the selected subset of document-location tuples.

One or more embodiments include one or more of the following features. The cartographic display attributes include a definition of a minimum average spatial scale and a definition of a maximum average spatial scale. The program further causes the computer system to perform the functions of selecting a subset of the set of document-location tuples based on whether the average spatial scale of the visual representation of the domain is between the minimum average spatial scale and the maximum average spatial scale. The program further causes the computer system to perform the functions of accepting user input changing the average spatial scale of the visual representation of the domain, and in response selecting a different subset of the set of document-location tuples based on the cartographic display attributes and on the changed average spatial scale of the visual representation of the domain. The program further causes the computer system to perform the functions of displaying the documents associated with the set of document-location tuples in a list. The cartographic display attributes include information based on a source of the document-location tuple.

Under another aspect, a method of displaying information about document-location tuples includes: accepting search criteria from a user, the search criteria including a free-text query and a domain identifier, the domain identifier identifying a domain in a metric vector space; in response to accepting the search criteria from the user, obtaining a set of document-location tuples from a corpus of documents, each document-location tuple satisfying the search criteria from the user, each location having associated cartographic display attributes; displaying a visual representation of the domain identified by the domain identifier, the visual representation of the domain having an average spatial scale; selecting a subset of the set of document-location tuples based on the cartographic display attributes and on the average spatial scale of the visual representation of the domain; and displaying a plurality of visual indicators representing the selected subset of document-location tuples.

One or more embodiments includes one or more of the following features. The cartographic display attributes include a definition of a minimum average spatial scale and a definition of a maximum average spatial scale. Selecting a subset of the set of document-location tuples based on whether the average spatial scale of the visual representation of the domain is between the minimum average spatial scale and the maximum average spatial scale. Accepting user input changing the average spatial scale of the visual representation of the domain, and in response selecting a different subset of the set of document-location tuples based on the cartographic display attributes and on the changed average spatial scale of the visual representation of the domain. Displaying the documents associated with the set of document-location tuples in a list. The cartographic display attributes include information based on a source of the document-location tuple.

Under another aspect, an interface program stored on a computer-readable medium causes a computer system with a display device to perform the functions of: accepting an initialization request from a user to initialize an interface with a location-related search engine; in response to accepting the initialization request from the user, obtaining illustrative search criteria based on a location-related search performed by a prior user interfacing with the location-related search engine, the illustrative search criteria including a free-text query and a domain identifier, the domain identifier identifying a domain in a metric vector space; obtaining a set of document-location tuples from a corpus of documents, each document-location tuple satisfying the illustrative search criteria; displaying on the display device a visual representation of the domain identified by the domain identifier; and displaying a plurality of visual indicators representing the set of document-location tuples.

One or more embodiments include one or more of the following features. The program further causes the computer system to perform the functions of, in response to the initialization request, displaying controls capable of accepting new search criteria from the user, the search criteria including a free-text query and a domain identifier identifying a domain in a metric vector space. The program further causes the computer system to perform the functions of: accepting new search criteria from the user, the new search criteria including a new free-text query and a new domain identifier identifying a domain in a metric vector space; in response to accepting said new search criteria from the user, obtaining a new set of document-location tuples from a corpus of documents, each new document-location tuple satisfying the new search criteria from the user; displaying on the display device a visual representation of the domain identified by the new domain identifier; and displaying a plurality of visual indicators representing the new document-location tuples. The metric vector space of the new search criteria includes the same metric vector space of the illustrative search criteria. The illustrative search criteria include search criteria entered by the prior user. The illustrative search criteria are based on document-location tuples obtained during the location-related search performed by the prior user. The illustrative search criteria are based on document-location tuples obtained and viewed by the prior user during the location-related search performed by the prior user. The program further causes the computer system to perform the functions of statistically analyzing search criteria entered by a plurality of prior users, and basing the illustrative search criteria on a frequency count of entered search criteria. The program further causes the computer system to perform the functions of statistically analyzing document-location tuples obtained during location-related searches performed by a plurality of prior users, and basing the illustrative search criteria on a frequency count of obtained document-location tuples. The program further causes the computer system to perform the functions of statistically analyzing document-location tuples obtained and viewed during location-related searches performed by a plurality of prior users, and basing the illustrative search criteria on a frequency count of obtained and viewed document-location tuples. The initialization request includes the user entering a web address for a website interfacing with the location-related search engine. The initialization request includes the user causing a web browser to load a web page with the location-related search engine. The initialization request includes the user clicking on hyperlink containing a web address for a website interfacing with the location-related search engine. The initialization request does not include search criteria from the user. The initialization request includes initialization search criteria from the user, and wherein the program further causes the computer system to perform the functions of displaying information responsive to both the initialization search criteria and the illustrative search criteria.

Under another aspect, A method of displaying information about document-location tuples includes: accepting an initialization request from a user to initialize an interface with a location-related search engine; in response to accepting the initialization request from the user, obtaining illustrative search criteria based on a location-related search performed by a prior user interfacing with the location-related search engine, the illustrative search criteria including a free-text query and a domain identifier, the domain identifier identifying a domain in a metric vector space; obtaining a set of document-location tuples from a corpus of documents, each document-location tuple satisfying the illustrative search criteria; displaying a visual representation of the domain identified by the domain identifier; and displaying a plurality of visual indicators representing the set of document-location tuples.

One or more embodiments include one or more of the following features. In response to the initialization request, displaying controls capable of accepting new search criteria from the user, the search criteria including a free-text query and a domain identifier identifying a domain in a metric vector space. Accepting new search criteria from the user, the new search criteria including a new free-text query and a new domain identifier identifying a domain in a metric vector space; in response to accepting said new search criteria from the user, obtaining a new set of document-location tuples from a corpus of documents, each new document-location tuple satisfying the new search criteria from the user; displaying a visual representation of the domain identified by the new domain identifier; and displaying a plurality of visual indicators representing the new document-location tuples. The metric vector space of the new search criteria includes the same metric vector space of the illustrative search criteria. The illustrative search criteria include search criteria entered by the prior user. The illustrative search criteria are based on document-location tuples obtained during the location-related search performed by the prior user. The illustrative search criteria are based on document-location tuples obtained and viewed by the prior user during the location-related search performed by the prior user. Statistically analyzing search criteria entered by a plurality of prior users, and basing the illustrative search criteria on a frequency count of entered search criteria. Statistically analyzing document-location tuples obtained during location-related searches performed by a plurality of prior users, and basing the illustrative search criteria on a frequency count of obtained document-location tuples. Statistically analyzing document-location tuples obtained and viewed during location-related searches performed by a plurality of prior users, and basing the illustrative search criteria on a frequency count of obtained and viewed document-location tuples. The initialization request includes the user entering a web address for a website interfacing with the location-related search engine. The initialization request includes the user causing a web browser to load a web page with the location-related search engine. The initialization request includes the user clicking on hyperlink containing a web address for a website interfacing with the location-related search engine. The initialization request does not include search criteria from the user. The initialization request includes initialization search criteria from the user, and further including displaying information responsive to both the initialization search criteria and the illustrative search criteria.

Under another aspect, an interface program stored on a computer-readable medium causes a computer system with a display device to perform the functions of: accepting search criteria from a user, the search criteria including a free-text query and a domain identifier, the domain identifier identifying a domain in a metric vector space; in response to accepting the search criteria from the user, obtaining a set of document-location tuples from a corpus of documents, each document-location tuple satisfying the search criteria from the user; and determining whether the document-location tuples are associated with a single document or are associated with a plurality of documents. If the document-location tuples are associated with multiple documents, the program causes the computer system to perform the functions of: displaying on the display device a visual representation of the domain identified by the domain identifier; displaying a plurality of visual indicators representing the document-location tuples; and for each document-location tuple, displaying a document summary including an identifier for the document, and a document text substring shorter than a specified maximum length. If the document-location tuples are associated with a single document, the program causes the system to perform the functions of: displaying on the display device a visual representation of the domain identified by the domain identifier; displaying a plurality of visual indicators representing the document-location tuples; displaying a document summary including an identifier for the document; and displaying a document text substring having a length longer than the specified maximum length.

One or more embodiments include one or more of the following features. If the document-location tuples are associated with a single document, the displayed document text substring is associated with multiple document-location tuples. The document-location tuples each include a document identifier, and the program further causes the computer system to determine whether the document-location tuples are associated with a single document or are associated with a plurality of documents by comparing the document identifier for each document-location tuple. The text substring includes a portion of text responsive to the free-text query entered by the user. The portion of text responsive to the free-text query entered by the user includes at least one of an exact string match to a portion of the free-text query, a partial string match to a portion of the free-text query, and a match to a step word derived from a portion of the free-text query. The document text substring displayed for the single document includes a substantial portion of the document text. The program further causes the computer system to perform the functions of, if the document-location tuples are associated with multiple documents, for each document-location tuple, displaying a means of accessing that document. The program further causes the computer system to perform the functions of, if the document-location tuples are associated with a single document, displaying a single means of accessing the document.

Under another aspect, a method of displaying information about document-location tuples includes: accepting search criteria from a user, the search criteria including a free-text query and a domain identifier, the domain identifier identifying a domain in a metric vector space; in response to accepting the search criteria from the user, obtaining a set of document-location tuples from a corpus of documents, each document-location tuple satisfying the search criteria from the user; and determining whether the document-location tuples are associated with a single document or are associated with a plurality of documents. If the document-location tuples are associated with multiple documents, the method further includes: displaying on the display device a visual representation of the domain identified by the domain identifier; displaying a plurality of visual indicators representing the document-location tuples; and for each document-location tuple, displaying a document summary including an identifier for the document, and a document text substring shorter than a specified maximum length. If the document-location tuples are associated with a single document, the method further includes: displaying on the display device a visual representation of the domain identified by the domain identifier; displaying a plurality of visual indicators representing the document-location tuples; displaying a document summary including an identifier for the document; and displaying a document text substring having a length longer than the specified maximum length.

One or more embodiments include one or more of the following features. If the document-location tuples are associated with a single document, the displayed document text substring is associated with multiple document-location tuples. The document-location tuples each include a document identifier, and the method further includes determining whether the document-location tuples are associated with a single document or are associated with a plurality of documents by comparing the document identifier for each document-location tuple. The text substring includes portions of text responsive to the free-text query entered by the user. The portion of text responsive to the free-text query entered by the user includes at least one of an exact string match to a portion of the free-text query, a partial string match to a portion of the free-text query, and a match to a step word derived from a portion of the free-text query. The document text substring displayed for the single document includes a substantial portion of the document text. If the document-location tuples are associated with multiple documents, for each document-location tuple, displaying a means of accessing that document. If the document-location tuples are associated with a single document, displaying a single means of accessing the document.

Under another aspect, an interface program stored on a computer-readable medium causes a computer system with a display device to perform the functions of: accepting search criteria from a user, the search criteria including a free-text query and a domain identifier, the domain identifier identifying a domain in a metric vector space; in response to accepting the search criteria from the user, dividing the domain identified by the domain identifier into a plurality of subdomains within the domain, and obtaining a plurality of subdomain identifiers identifying the corresponding subdomains; for each subdomain identifier, obtaining a set of document-location tuples from a corpus of documents, each document-location tuple satisfying the free-text query and the subdomain identifier; displaying on the display device a visual representation of the domain identified by the domain identifier; and displaying a plurality of visual indicators representing the document-location tuples obtained for one or more of the subdomain identifiers.

One or more embodiments include one or more of the following features. Dividing the domain identified by the domain identifier includes dividing the domain into subdomains of approximately equal size. Dividing the domain identified by the domain identifier includes dividing the domain into subdomains based on a grid. The domain identifier and the subdomain identifiers include bounding boxes. The user specifies at least one of a maximum number of locations and a maximum number of document-location tuples to be retrieved for each subdomain. The program specifies at least one of a maximum number of locations and a maximum number of document-location tuples to be retrieved for each subdomain.

Under another aspect, an interface program stored on a computer-readable medium causes a computer system with a display device to perform the functions of: accepting search criteria from a user, the search criteria including a free-text query and a domain identifier, the domain identifier identifying a domain in a metric vector space; in response to accepting the search criteria from the user, obtaining a plurality of sets of document-location tuples from a corpus of documents, each document-location tuple satisfying the free-text query and a subdomain identifier identifying a subdomain within the identified domain; displaying on the display device a visual representation of the domain identified by the domain identifier; and displaying a plurality of visual indicators representing the document-location tuples.

One or more embodiments include one or more of the following features. The domain identifier and the subdomain identifiers include bounding boxes. The user specifies at least one of a maximum number of locations and a maximum number of document-location tuples to be retrieved for each subdomain. The program specifies at least one of a maximum number of locations and a maximum number of document-location tuples to be retrieved for each subdomain.

Under another aspect, a method of displaying information about document-location tuples includes accepting search criteria from a user, the search criteria including a free-text query and a domain identifier, the domain identifier identifying a domain in a metric vector space; in response to accepting the search criteria from the user, dividing the domain identified by the domain identifier into a plurality of subdomains within the domain, and obtaining a plurality of subdomain identifiers identifying the corresponding subdomains; for each subdomain identifier, obtaining a set of document-location tuples from a corpus of documents, each document-location tuple satisfying the free-text query and the subdomain identifier; displaying a visual representation of the domain identified by the domain identifier; and displaying a plurality of visual indicators representing the document-location tuples obtained for one or more of the subdomain identifiers.

One or more embodiments include one or more of the following features. Dividing the domain identified by the domain identifier includes dividing the domain into subdomains of approximately equal size. Dividing the domain identified by the domain identifier includes dividing the domain into subdomains based on a grid. The domain identifier and the subdomain identifiers include bounding boxes. The user specifies at least one of a maximum number of locations and a maximum number of document-location tuples to be retrieved for each subdomain. Specifying at least one of a maximum number of locations and a maximum number of document-location tuples to be retrieved for each subdomain.

Under another aspect, a method of displaying information about document-location tuples includes: accepting search criteria from a user, the search criteria including a free-text query and a domain identifier, the domain identifier identifying a domain in a metric vector space; in response to accepting the search criteria from the user, obtaining a plurality of sets of document-location tuples from a corpus of documents, each document-location tuple satisfying the free-text query and a subdomain identifier identifying a subdomain within the identified domain; displaying a visual representation of the domain identified by the domain identifier; and displaying a plurality of visual indicators representing the document-location tuples.

One or more embodiments include one or more of the following features. The domain identifier and the subdomain identifiers include bounding boxes. The user specifies at least one of a maximum number of locations and a maximum number of document-location tuples to be retrieved for each subdomain. Specifying at least one of a maximum number of locations and a maximum number of document-location tuples to be retrieved for each subdomain.

The details of one or more embodiments of the invention are set forth in the accompanying drawings and the description below. Other features, objects, and advantages of the invention will be apparent from the description and drawings, and from the claims.

### DEFINITIONS

For clarity, we define several terms of art:

“Data” is any media object that can be represented by numbers, such as numbers in base two, which are called “binary numbers.”

“Information” is data that a human or machine or a machine can interpret as having meaning.

“Metadata” is information about other information. For example, a document is a media object containing information and possibly also metadata about the information. For example, if a document contains text by an author named “Dave,” then the document may also contain metadata identifying Dave as the author. Metadata often performs the function of “identifying” part of a media object. The metadata usually identifies part of a media object in order to provide additional information about that part of the media object. The mechanism for identifying part of a media object usually depends on the format and specific composition of a given media object. For text documents, character ranges are often used to identify substrings of the text. These substrings are media objects.

A “media object” is any physical or electronic object that can be interpreted as containing information, thoughts, or emotions. Thus, a media object is a broad class of things, including such diverse objects as living organisms, paper documents, rocks, videos, email messages, web pages, slide show presentations, spreadsheets, renderings of equations, and music.

A “digital media object” is a media object constructed from binary electronic signals or similar computing-machine oriented signals. Frequently, media objects can be stored in digital form, and this digital form can be replicated and transmitted to different computer systems many separate times.

A “document” is a media object containing information composed by humans for the purpose of transmission or archiving for other humans. Documents are typically the targets of the queries issued by users to search systems. Examples of documents include text-based computer files, as well as files that are partially text-based, files containing spatial information, and computer entities that can be accessed via a document-like interface. Documents can contain other documents and may have other interfaces besides their document-like interfaces. Every document has an address. In the case of world-wide web documents, this address is commonly a URL. The documents exist on computer systems arrayed across a computer network, such as a private network or the Internet. The documents may be hyperlinked, that is, may contain references (hyperlinks) to an address of another document. Copies of the documents may be stored in a repository.

A “digital document” is a document that is a digital media object, such as a file stored in a file system or web server or digital document repository.

A “text document” is a document containing character symbols that humans can interpret as signifying meaning. A “digital text document” is a text document that is also a digital document. Typically, digital text documents contain character symbols in standardized character sets that many computer systems can interpret and render visually to users. Digital text documents may also contain other pieces of information besides text, such as images, graphs, numbers, binary data, and other signals. Some digital documents contain images of text, and a digital representation of the text may be separated from the digital document containing the images of text.

A “corpus of documents” is a collection of one or more documents. Typically, a corpus of documents is grouped together by a process or some human-chosen convention, such as a web crawler gathering documents from a set of web sites and grouping them together into a set of documents; such a set is a corpus. The plural of corpus is corpora.

A “subcorpus” is a corpus that is fully contained within a larger corpus of documents. A subcorpus is simply another name for a subset of a corpus.

A “summary” is a media object that contains information about some other media object. By definition, a summary does not contain all of the information of the other media object, and it can contain additional information that is not obviously present in the other media object.

An “integrated summary” is a set of summaries about the same media object. For example, a web site about a book typically has several summaries organized in different ways and in different mediums, although they are all about the same book. An integrated summary can include both sub-media objects excerpted from the media object summarized by the integrated summary, and also summary media objects.

To “summarize” is to provide information in the form of a media object that is a selection of less than all of the information in a second media object possibly with the addition of information not contained in the second media object. A summary may simply be one or more excerpts of a subset of the media object itself. For example, a text search engine often generates textual summaries by combining a set of excerpted text from a document. A summary may be one or more sub-strings of a text document connected together into a human-readable string with ellipses and visual highlighting added to assist users reading the summary. For example, a query for “cars” might cause the search engine to provide a search result listing containing a list item with the textual summary “ . . . highway accidents often involve <b>cars</b> that . . . dangerous pileups involving more than 20 <b>cars</b> . . . ” In this example, the original media object contained the strings “highway accidents often involve cars that” and “dangerous pileups involving more than 20 cars”, and the summary creation process added the strings “ . . . ” and “<b>” and “</b>” to make it easier for users to read the concatenated strings. These substrings from a document and represented to a user are an example of a “fragment” of a media object.

A “statistically interesting phrase” or “SIP” is a substring of a text that is identified as interesting. Often, the method of determining which phrases are interesting is an automated or semi-automated process that relies on statistical information gathered from corpora of documents. For example, one way of identifying SIPs is to statistically assess which phrases are relatively common in a given text but relatively uncommon in a reference corpus. This determines interestingness of phrases in the text relative to the statistical background of the reference corpus. For example, the phrase “tree farm” may occur twice in a document containing a hundred pairs of words. That means it has a relative frequency of about 1%. Meanwhile, the phrase “tree farm” might only occur ten times in a reference corpus containing ten million pairs of words, i.e. one in a million chance of randomly choosing that pair of words out of all the pairs. Since one-in-one-hundred is much larger than one-in-one-million, the phrase “tree farm” stands out against the statistical backdrop of the reference corpus. By computing the ratio of these two frequencies, one obtains a likelihood ratio. By comparing the likelihood ratios of all the phrases in a document, a system can find statistically interesting phrases. One notices that simply because of finite size effects, that the smallest possible frequency of occurrence for a phrase in a short text is certain to be much larger than the frequencies of many phrases in a large reference corpus. This observation underscores the importance of comparing likelihood ratios, rather than treating each such score as containing much independent meaning of its own. Nonetheless, likelihood ratio comparisons are one effective way of identifying SIPs.

A “sub-media object” is a media object that is part of a second media object. For example, a chapter in a book is a sub-media object of the book, and a paragraph in that chapter is a sub-media object of the chapter. A pixel in a digital image is a sub-media object of the digital image. A sub-media object is any fragment of a larger media object. For example, a fragment of a document might be an image of a portion of the document, such is commonly done with digital scans of paper documents. A fragment of a text document might be a string of symbols contained in the text document and represented to a user. Since digital media objects can be replicated ad infinitum, a sub-media object of a digital media object can accurately reproduce any portion of the original media object without necessarily becoming a sub-summary.

A “sub-summary” is summary of a sub-media object. A summary may simply be a set of one or more sub-media objects excerpted from the original media object. The word “sub-summary” is defined here for clarity: a summary of a sub-media object is just as much a summary as other types of summaries, however in relation to a “containing summary” about a larger fragment of the original work, a sub-summary describes a smaller part than the containing summary that summarizes the larger fragment.

A “metric space” is a mathematical conceptual entity defined as follows: a metric space is a set of elements possibly infinite in number and a function that maps any two elements to the real numbers with the following properties. A metric on a set X is a function (called the distance function or simply distance)
d: X×X→R

(where R is the set of real numbers). For all x, y, z in X, this function is required to satisfy the following conditions:
d(x,y)≧0 (non-negativity) 1.
d(x,y)=0 if and only if x=y (identity of indiscernibles) 2.
d(x,y)=d(y,x) (symmetry) 3.
d(x,z)≦d(x,y)+d(y,z) (subadditivity/triangle inequality). 4.

A “vector space” is a mathematical conceptual entity with the following properties: Let F be a field (such as the real numbers or complex numbers), whose elements will be called scalars. A vector space over the field F is a set V together with two binary operations:
vector addition: V×V→V denoted v+w, where v, wεV, and
scalar multiplication: F×V→V denoted a v, where aεF and vεV,

satisfying the axioms below. Four require vector addition to be an Abelian group, and two are distributive laws.

1. Vector addition is associative: For all u, v, wεV, we have u+(v+w)=(u+v)+w.

2. Vector addition is commutative: For all v, wεV, we have v+w=w+v.

3. Vector addition has an identity element: There exists an element 0εV, called the zero vector, such that v+0=v for all vεV.

4. Vector addition has an inverse element: For all vεV, there exists an element wεV, called the additive inverse of v, such that v+w=0.

5. Distributivity holds for scalar multiplication over vector addition: For all aεF and v, wεV, we have a (v+w)=a v+a w.

6. Distributivity holds for scalar multiplication over field addition: For all a, bεF and vεV, we have (a+b) v=a v+b v.

7. Scalar multiplication is compatible with multiplication in the field of scalars: For all a, bεF and vεV, we have a (b v)=(ab) v.

8. Scalar multiplication has an identity element: For all vεV, we have 1 v=v, where 1 denotes the multiplicative identity in F.

Formally, these are the axioms for a module, so a vector space may be concisely described as a module over a field.

A “metric vector space” is a mathematical conceptual entity with the properties of both a vector space and a metric space.

The “dimension” of a vector space is the number of vectors in the equivalence class of basis vectors that minimally span the vector space.

A “line segment” is a geometric entity in a metric space defined by two entities in the metric space. These two entities are referred to as the “ends” of the line segment. The line segment is the two ends plus the concept of a shortest path connecting them, where the path length is determined by the metric on the metric space.

A “domain” is an arbitrary subset of a metric space. Examples of domains include a line segment in a metric space, a polygon in a metric vector space, and a non-connected set of points and polygons in a metric vector space.

A “domain identifier” is any mechanism for specifying a domain. For example, a list of points forming a bounding box or a polygon is a type of domain identifier. A map image is another type of domain identifier. In principle, a name for a place can constitute a domain identifier, but this is a less common type of domain identifier, because it lacks the explicit representation of dimensionality that a map image has.

A “sub-domain” is a domain which is a subset of another domain. For example, if one is considering a domain that is a polygon, then an example of a sub-domain of that domain is a line segment or subset of line segments selected from the set of line segments that make up the polygon.

A “point” is an entity in a metric vector space. It can be defined by a set of coordinates in a coordinate system describing the space. A point has zero volume, area, and length. Entities in a vector space are often called “features,” so a “point feature” is a location defined simply by a single point. One often uses “centroid points” (also known as “centroid coordinates”) to simplify the description of more complicated entities, such as polygons. A centroid can be computed by finding the average value of each of the multiple coordinates used in defining the many points that make up a feature. This is also called the “center of mass” point. There can be different averaging techniques that generate somewhat different centroid coordinates. The key point of centroid coordinates is to identify a representative point for a geometric entity in a metric vector space.

A “polyline” is an ordered set of entities in a metric space. Each adjacent pair of entities in the list is said to be “connected” by a line segment.

A “polygon” is a polyline with the additional property that it implicitly includes a line segment between the last element in the list and first element in the list.

A “polyhedron” is a set of polygons with some of the line segments inherent in the underlying polylines are associated with line segments from other polygons in the set. A “closed” polyhedron is a polyhedron in a metric vector space and every line segment is associated with a sufficient number of other line segments in the set that one can identify an interior domain and an exterior domain such that any line segment connecting an element of the interior domain to an element of the exterior domain is guaranteed to intersect a polygon in the set.

A “bounding box” is a right-angled polyhedron that contains a particular region of space. Its “box” nature is based on the polyhedron's square corners. It is a “bounding” nature is based on its being the minimum such shape that contains the region of interest. A bounding box is a common way of specifying a domain of interest, because it is technically easy to implement systems that display, transmit, and allow navigation of right-angled display elements—especially in two dimensions.

A “spatial domain” is a domain in a metric vector space.

A “coordinate system” is any means of referring to locations within a spatial domain. For example, a so-called Cartesian coordinate system on a real-valued metric vector space is a tuple of real numbers measuring distances along a chosen set of basis vectors that span the space. Many examples of coordinate systems exist. “Unprojected latitude-longitude” coordinates on a planet, like Earth, are an example of two-dimensional spherical coordinates on a sphere embedded in three-dimensional space. A “datum” is a set of reference points from which distances are measured in a specified coordinate system. For example, the World Grid System 1984 (WGS84) is commonly used because the Global Position System (GPS) uses WGS84 as the defining datum for the coordinates that it provides. For coordinate systems used to describe geographic domains, one often speaks of “projected” coordinate systems, which are coordinates that can be related to unprojected latitude-longitude via mathematical functions and procedures called “projection functions.” Other types of coordinate systems use grids to divide a particular domain into subdomains, e.g. the Military Grid Reference System (MGRS) divides the Earth into subdomains labeled with letters and numbers. Natural language references to places are a coordinate system in the general sense that people often recognize a phrase like “Cambridge” as meaning a place, but there may be many such places. Such ambiguity is typically not tolerated in the design of coordinate systems, so an important part of constructing location-related content is coping with such ambiguity, either by removing it or describing it or simply stating that it exists.

A “physical domain” is a spatial domain that has a one-to-one and onto association with locations in the physical world in which people could exist. For example, a physical domain could be a subset of points within a vector space that describes the positions of objects in a building. An example of a spatial domain that is not a physical domain is a subset of points within a vector space that describes the positions of genes along a strand of DNA that is frequently observed in a particular species. Such an abstract spatial domain can be described by a map image using a distance metric that counts the DNA base pairs between the genes. An abstract space, humans could not exist in this space, so it is not a physical domain.

A “geographic domain” is a physical domain associated with the planet Earth. For example, a map image of the London subway system depicts a geographic domain, and a CAD diagram of wall outlets in a building on Earth is a geographic domain. Traditional geographic map images, such as those drawn by Magellan depict geographic domains.

A “location” is a spatial domain. Spatial domains can contain other spatial domains. A spatial domain that contains a second spatial domain can be said to encompass the second spatial domain. Since some spatial domains are large or not precisely defined, any degree of overlap between the encompassing spatial domain and the encompassed location is considered “encompassing.” Since a spatial domain is a set of elements from a metric vector space, the word “encompassing” means that the logical intersection of the sets of elements represented by the two spatial domains in question is itself a non-empty set of elements. Often, “encompassing” means that all of the elements in the second spatial domain are also elements in the encompassing domain. For example, a polygon describing the city of Cambridge is a location in the spatial domain typically used to represent the state of Massachusetts. Similarly, a three-dimensional polyhedron describing a building in Cambridge is a location in the spatial domain defined by the polygon of Cambridge. The word “location” is a common parlance synonym for a “spatial domain.”

“Proximate locations” are locations that are closer together than other locations. Closeness is a broad concept. The general notion of closeness is captured by requiring that proximate locations be contained within a circle with a radius less the distance between other locations not considered proximate. Any distance metric can be used to determine the proximity of two results. A plurality of proximate locations is a set of locations that have the spatial relationship of being close together.

The “volume” of a domain is a measure of the quantity of space contained inside the domain. The volume is measured by the metric along each of the dimensions of the space, so the units of volume of the units of the metric raised to the dimension of the space, i.e. Lˆd. For one-dimensional spaces, domains have volume measured simply by length. For two-dimensional spaces, domains have volume measured by area, that is, length squared.

A domain can be viewed as a list of points the space. A domain is said to “contain” a point if the point is in the list. The list may be infinite or even innumerable. A domain is said to “contain” another domain if 100% of the other domains's points are contained in the domain. A domain is said to “partially contain” another domain if more than 0% but less than 100% % of the other domain's points are contained in the domain.

A “location reference” is a sub-media object of a document that a human can interpret as referring to a location. For example, a sub-string of a document may be “Cambridge, Mass.,” which a human can interpret as referring to an entity with representative coordinates longitude-latitude coordinates (−71.1061, 42.375). As another example, a location reference may be the name of an organization, such as “the Administration,” which in some contexts means the US Presidential Administration and its main offices at the White House in Washington, D.C.

Two locations are said to be “co-referenced” if a single document contains location references to both locations.

A “candidate location reference” is a submedia object identified in a media object, where the submedia object may refer to a location. Typically, a candidate location reference is identified by a set of metadata that also includes a confidence score indicating the likelihood that the identified submedia object actually refers to the location.

A “multi-dimensional map” is a map representing a domain with more than one dimension.

A “statistical property” is a piece of metadata about a piece of information generated by analyzing the information using statistical techniques, such as averaging or comparing the information to averages gathered from reference information. For example, a document has information in it that can be statistically analyzed by comparing the frequency of occurrence of consecutive pairs of words in the document to the frequency of occurrence of those pairs in a reference corpus of documents. The resulting statistical property is a ratio of frequencies. Other statistical properties exist. Statistical properties are often used to distinguish a subset of information from a larger set of information. For example, given a set of documents, one might analyze them to compute a statistical property that differentiates a subset of those documents as being more relevant to a user's query. As another example, a system may analyze information in a media object to decide how likely it is that it refers to a particular location. The result confidence score is a statistical property of the document-location tuple, and it can be used to distinguish it relative to other document-location tuples.

A “document-location tuple” is a two-item set of information containing a reference to a document (also known as an “address” for the document) and a domain identifier that identifies a location.

A “geospatial reference” is a location reference to a location within a geographic domain.

“Location-related content” is information that can be interpreted as identifying or referring to a location within a spatial domain. Location-related content can be associated with a media object in many ways. For example, location-related content may be contained inside the media object itself as location references, such as names of places, explicit latitude-longitude coordinates, identification numbers of objects or facilities or buildings. For another example, location-related content may be associated with a media object by a system that associates a reference to a media object with location-related content that is separate from the media object itself. Such a system might be a database containing a table with a URL field and a latitude-longitude field in a table. To obtain location-related content associated with a media object, a person or computer program might pass the media object to a geoparsing engine to extract location-related content contained inside the media object, or it might utilize a system that maintains associations between references to media objects and location-related content. The fact that a creator of a media object once lived in a particular place is a piece of location-related content associated with the media object. Other examples of such auxiliary location-related content are the locations of physical copies of the media object and locations of people interested in the media object.

A “sub-media object that is not a location-related content” is a sub-media object that is not a location reference. For example, a fragment of a text document that says “Eat great pizza in” is not location-related content even though the subsequent string may be a location reference.

A “spatial relationship” is information that can be interpreted as identifying or referring to a geometric arrangement, ordering, or other pattern associated with a set of locations. For example, “the aliens traveled from Qidmore Downs to Estheral Hill,” describes a spatial relationship that organizes the location references “Qidmore Downs” and “Estheral Hill” into an ordering. Another name for a spatial relationship is a geometric relationship.

A “reference to a media object” is a means of identifying a media object without necessarily providing the media object itself. For example, a URL is a reference to a media object. For another example, media object title, author, and other bibliographic information that permits unique identification of the media object is a reference to that media object.

A “graph” is a set of items (often called “nodes”) with a set of associations (often called “links”) between the items. A “weighted graph” is a graph in which the associations carry a numerical value, which might indicate the distance between the items in the set when embedded in a particular space. A “direct” graph is a graph in which the associations have a defined direction from one item to the other item.

A “cycle” is a subset of links in a graph that form a closed loop. A cycle in a directed graph must have all the links pointing in one direction around the loop, so that it can be traversed without going against the direction of the associations. An “acycle graph” is a graph that contains no cycles.

A “directed acyclic graph” is a graph with directed links and no cycles. A “hierarchy” is a name for a directed acyclic graph. “DAG” is another name for a direct acyclic graph. One type of DAG relevant to our work here is a DAG constructed from partial containment of geometric entities in a space. Since a geometric entity can overlap multiple other areas, the graph of relationships between them is usually not a tree. In principle, a network of partial containment relationships is not even a DAG because cycles can emerge from sets of multiply overlapping locations. Nonetheless, one can usually remove these cycles by making judgment calls about which locations ought to be considered parent nodes for a particular purpose. For example, a DAG could be constructed from the states of New England, the region known as New England, and the region known as the “New England seaboard.” If a data curator decides that New England is the parent node for all the states and all the states are parent nodes to the New England seaboard, then a three level DAG has been constructed. The curator could have made another organization of the relationships.

A “tree” is a directed acyclic graph in which every node has only one parent.

A “general graph” is just a graph without any special properties identified.

An “image” is a media object composed of a two-dimensional or three-dimensional array of pixels that a human can visually observe. An image is a multi-dimensional representation of information. The information could come from a great variety of sources and may describe a wide range of phenomena. Pixels may be black/white, various shades of gray, or colored. Often a three-dimensional pixel is called a “voxel.” An image may be animated, which effectively introduces a fourth dimension. An animated image can be presented to a human as a sequence of two- or three-dimensional images. A three-dimensional image can be presented to a human using a variety of techniques, such as a projection from three-dimensions into two-dimensions or a hologram or a physical sculpture. Typically, computers present two-dimensional images on computer monitors, however, some human-computer interfaces present three-dimensional images. Since an image is a multi-dimensional representation of information, it implies the existence of a metric on the information. Even if the original information appears to not have a metric, by representing the information in an image, the process of creating the image gives the information a metric. The metric can be deduced by counting the number of pixels separating any two pixels in the image. If the image is animated, then the distance between pixels in two separate time slices includes a component from the duration of time that elapses between showing the two time slices to the human. Typically, a Euclidean metric is used to measure the distance between pixels in an image, however other metrics may be used. Since images can be interpreted as having a metric for measuring the distance between pixels, they are representations of domains. Typically, images are representations of spatial domains. An image of a spatial domain that is associated with the planet Earth is typically called a “geographic map.” An image of another spatial domain may also be called a “map,” but it is a map of a different type of space. For example, an image showing the fictional location known as “Middle Earth” described in the novels by Tolkien is a type of map, however the locations and domains displayed in such a map are not locations on planet Earth. Similarly, one may view images showing locations on the planet Mars, or locations in stores in the city of Paris, or locations of network hubs in the metric space defined by the distances between router connections on the Internet, or locations of organs in the anatomy of the fish known as a Large-Mouth Bass. An image depicting a spatial domain allows a person to observe the spatial relationships between locations, such as which locations are contained within others and which are adjacent to each other. A subset of pixels inside of an image is also an image. Call such a subset of pixels a “sub-image”. In addition to simply depicting the relationships between locations, an image may also show conceptual relationships between entities in the metric space and other entities that are not part of that metric space. For example, an image might indicate which people own which buildings by showing the locations of buildings arranged in their relative positions within a domain of a geographic metric space and also showing sub-images that depict faces of people who own those buildings. Other sub-images may be textual labels or iconography that evokes recognition in the human viewer.

A “map image” is an image in which one or more sub-images depict locations from a spatial domain. A “geographic map image” is a map image in which the spatial domain is a geographic space. Map images are also called “raster graphics” because like a television image they consist of an array of pixels that are either on or off, or showing varying levels of color or grayness.

“Scale” is the ratio constructed from dividing the physical distance in a map image by the metric distance that it represents in the actual domain. A “high scale” image is one in which the depiction in the map image is closer to the actual size than a “low scale” image. The act of “zooming in” is a request for a map image of higher scale; the act of “zooming out” is a request for a map image of lower scale.

A “search engine” is a computer program that accepts a request from a human or from another computer program and responding with a list of references to media objects that the search engine deems relevant to the request. Another name for a request to search engine is “search query” or simply a “query.” Common examples of search engines include: free-text search engines that display lists of text fragments from media objects known as “web pages;” image search engines that accept free-text or other types of queries from users and present sets of summaries of images, also known as “image thumbnails;” commerce sites that allow users to navigate amongst a selection of product categories and attributes to retrieve listings of products; and online book stores that allow users to input search criteria in order to find books that match their interests. Frequently, a result set from a book search engine will contain just one result with several different types of summaries about the one book presented in the result list of length one. Related books are often described on pages that are accessible via a hyperlink; clicking such a hyperlink constructs a new query to the book search engine, which responds by generating a new page describing the new set of results requested by the user.

A “search result listing” is the list of references provided by a search engine.

A “search user” is a person using a search engine.

A “text search engine” is a search engine that accepts character symbols as input and responds with a search result listing of references to text documents.

A “string” is a list of characters chosen from some set symbols (an alphabet) or other means of encoding information. A “free text string” is a string generated by a human by typing, speaking, or some other means of interacting with a digital device. Typically, the string is intended to represent words that might be found in a dictionary or in other media objects. However, the point of the “free” designator is that the user can enter whatever characters they like without necessarily knowing that they have been combined that way ever before. That is, by entering a free text string, a user is creating a new string.

A “free text query” is a search engine query based on a free text string input by a user. While a free text query be used as an exact filter on a corpus of documents, it is common to break the string of the free text query into multiple substrings that are matched against the strings of text in the documents. For example, if the user's query is “car bombs” a document that mentions both (“car” and “bombs”) or both (“automobile” and “bomb”) can be said to be responsive to the user's query. The textual proximity of the words in the document may influence the relevance score assigned to the document. Removing the letter “s” at the end of “bombs” to make a root word “bomb” is called stemming.

A “geographic search engine” or “geographic text search engine” or “location-related search engine” or “GTS” is a search engine that provides location-based search user interfaces and tools for finding information about places using free-text query and domain identifiers as input, for example as described in U.S. Pat. No. 7,117,199. A GTS generally produces a list of document-location tuples as output. A GTS produces document-location tuples in response to search criteria including a free-text query and a domain identifier identifying a domain in a metric vector space, such as a bounding box of a domain or a name of a location in the space. A GTS engine uses a relevance function to assign relevance scores to documents in a corpus of documents and location references in the documents. The resulting relevance scores allow the GTS to sort the document-location tuples that satisfy the search criteria and present the highest ranked tuples to the user.

A “user interface” is a visual presentation to a person. A “search user interface” is a user interface presented to a search user by a search engine.

A “display area” is a visual portion of a user interface. For example, in an HTML web page, a DIV element with CSS attributes is often used to specify the position and size of an element that consumes part of the visual space in the user interface.

A “text area” is a display area containing text and possibly other types of visual media.

A “map area” is a display area containing a map image and possibly other types of visual media.

A “graph area” is a display area containing a visual representation of a graph and possibly other types of visual media.

A “variable display element” is a class of display areas that encode a numerical value, such as a relevance score, in a visual attribute. Any instance of a given class of variable display elements can be easily visually compared with other instances of the class. For example, map visual indicators or markers with color varying from faint yellow to blazing hot orange-red can be easily compared. Each step along the color gradient is associated with an underlying numerical value. As another example, a map marker might have variable opacity, such that one end of the spectrum of values is completely transparent and the other extreme of the spectrum is totally opaque. As another example, background colors can be used to highlight text and can be a class of variable display elements using a gradient of colors, such as yellow-to-red.

A “human-computer interface device” is a hardware device that allows a person to experience digital media objects using their biological senses.

A “visual display” is a media object presented on a human-computer interface device that allows a person to see shapes and symbols arranged by the computer. A visual display is an image presented by a computer.

Computer systems often handle “requests” from users. There are many ways that a computer system can “receive a request” from a user. A mouse action or keystroke may constitute a request sent to the computer system. An automatic process may trigger a request to a computer system. When a user loads a page in a web browser, it causes the browser to send a request to one or more web servers, which receive the request and respond by sending content to the browser.

A “visual indicator” is a sub-image inside of a visual display that evokes recognition of a location or spatial relationship represented by the visual display.

A “marker symbol” is a visual indicator comprised of a sub-image positioned on top of the location that it indicates within the spatial domain represented by the visual display.

An “arrow” is a visual indicator comprised of an image that looks like a line segment with one end of the line segment closer to the location indicated by the visual indicator and the other end farther away, where closer and farther away are determined by a metric that describes the visual display.

The word “approximate” is often used to describe properties of a visual display. Since a visual display typically cannot depict every single detailed fact or attribute of entities in a space, it typically leaves out information. This neglect of information leads to the usage of the term approximate and often impacts the visual appearance of information in a visual display. For example, a visual indicator that indicates the location “Cambridge, Mass.” in a geographic map image of the United States might simply be a visual indicator or marker symbol positioned on top of some of the pixels that partially cover the location defined by the polygon that defines the boundaries between Cambridge and neighboring towns. The marker symbol might overlap other pixels that are not contained within Cambridge. While this might seem like an error, it is part of the approximate nature of depicting spatial domains.

A “spatial thumbnail” is a visual display of a summary of a media object that presents to a user location-related content or spatial relationships contained in the media object summarized by the spatial thumbnail.

A “digital spatial thumbnail” is a spatial thumbnail comprised of a digital media object that summarizes a second media object, which might be either digital media object or other form of media object.

A “companion map” is a visual display that includes one or more spatial thumbnails and the entire media object summarized by the spatial thumbnail. If a companion map is a sub-summary, then may include only the sub-media object and not the entirety of the larger media object from which the sub-media object is excerpted.

An “article mapper application” is a computer program that provides companion maps for a digital media object.

To “resolve” a location reference is to associate a sub-media object with an entity in a metric space, such as a point in a vector space. For example, to say that the string “Cambridge, Mass.” means a place with coordinates (−71.1061, 42.375) is to resolve the meaning of that string.

A “geoparsing engine” is a computer program that accepts digital media objects as input and responds with location-related content extracted from the media object and resolved to entities in a metric space. While the name “geoparsing engine” includes the substring “geo”, in principle a geoparsing engine might extract location-related content about locations in non-geographic spatial domains, such as locations within the anatomy of an animal or locations with a metric space describing DNA interactions or protein interactions. Such a system might simply be called a “parsing engine.”

A “text geoparsing engine” is a geoparsing engine that accepts digital text documents as input and responds with location-related content extracted from the document and resolved to entities in a metric space.

An “automatic spatial thumbnail” is a spatial thumbnail generated by a geoparsing engine without a human manually extracting and resolving all of the location references of the media object summarized by the spatial thumbnail. An automatic spatial thumbnail might be semi-automatic in the sense that a human might edit portions of the spatial thumbnail after the geoparsing engine generates an initial version. The geoparsing engine may operate by generating so-called “geotags,” which are one type of location-related content that uses SGML, XML, or another type of compute-readable format to describe locations and spatial relationships in a spatial domain, such as a geographic domain.

An “automatic spatial thumbnail of a text document” is an automatic spatial thumbnail generated by a text geoparsing engine in response to a digital text document.

An “integrated spatial thumbnail” is an integrated summary that includes as one or more spatial thumbnails. An integrated spatial thumbnail may include sub-media objects excerpted from the media object being summarized, which illustrate location references that relate to the location-related content summarized by the spatial thumbnail. For example, an integrated spatial thumbnail that summarizes a PDF file might show text excerpted from the PDF file and a spatial thumbnail with a geographic map image showing visual indicators on locations described in the PDF's text. For another example, an integrated spatial thumbnail that summarizes a movie might show a text transcript of words spoken by actors in the movie and a spatial thumbnail showing the animated path of two of the movie's protagonists through a labyrinth described in the film.

An “automatic integrated spatial thumbnail” is an integrated spatial thumbnail in which one or more of the spatial thumbnails is an automatic spatial thumbnail.

A “representation of location-related content” is a visual display of associated location-related content. Since location-related content describes domains and spatial relationships in a metric space, a representation of that content uses the metric on the metric space to position visual indicators in the visual display, such that a human viewing the visual display can understand the relative positions, distances, and spatial relationships described by the location-related content.

A “web site” is a media object that presents visual displays to people by sending signals over a network like the Internet. Typically, a web site allows users to navigate between various visual displays presented by the web site. To facilitate this process of navigating, web sites provide a variety of “navigation guides” or listings of linkages between pages.

A “web site front page” is a type of navigation guide presented by a web site.

A “numerical score” is a number generated by a computer program based on analysis of a media object. Generally scores are used to compare different media objects. For example, a computer program that analysis images for people's faces might generate a score indicating how likely it is that a given contains an image of a person's face. Given a set of photos with these scores, those with the highest score are more likely to contain faces. Scores are sometimes normalized to range between zero and one, which makes them look like probabilities. Probabilistic scores are useful, because it is often more straightforward to combine multiple probabilistic scores than it is to combine unnormalized scores. Unnormalized scores range over a field of numbers, such as the real numbers, integers, complex numbers, or other numbers.

A “relevance score” is a numerical score that is usually intended to indicate the likelihood that a user will be interested in a particular media object. Often, a relevance score is used to rank documents. For example, a search engine often computes relevance scores for documents or for phrases that are responsive to a user's query. Media objects with higher relevance scores are more likely to be of interest to a user who entered that query.

A “confidence score” is a numerical score that is usually intended to indicate the likelihood that a media object has particular property. For example, a confidence score associated with a candidate location reference identified in a document is a numerical score indicating the likelihood that the author of the document intended the document to have the property that it refers to the candidate location. Confidence scores can be used for many similar purposes; for example, a system that identifies possible threats to a war ship might associate confidence scores with various events identified by metadata coming from sensor arrays, and these confidence scores indicate the likelihood that a given event is in fact a physical threat to the ship.

A “spatial cluster” is a set of locations that have been identified as proximate locations. For example, given a set of locations associated with a set of document-location tuples, one can identify one or more subsets of the locations that are closer to each other than to other locations in the set. Algorithms for detecting spatial clusters come in many flavors. Two popular varieties are k-means and partitioning. The k-means approach attempts to fit a specified number of peaked functions, such as Gaussian bumps, to a set of locations. By adjusting the parameters of the functions using linear regression or another fitting algorithm, one obtains the specified number of clusters. The fitting algorithm generally gives a numerical score indicating the quality of the fit. By adjusting the number of specified locations until a locally maximal fit quality is found, one obtains a set of spatially clustered locations. The partitioning approach divides the space into approximately regions with approximately equal numbers of locations from the set, and then subdivides those regions again. By repeating this process, one eventually defines regions surrounding each location individually. For each region with more than one location, one can compute a minimal bounding box or convex hull for the locations within it, and can then compute the density of locations within that bounding box or convex hull. The density is the number of locations divided by the volume (or area) of the convex hull or bounding box. These densities are numerical scores that can be used to differentiate each subset of locations identified by the partitioning. Subsets with high density scores are spatial clusters. There are many other means of generating spatial clusters. They all capture the idea of finding a subset of locations that are closer to each other than other locations.

A phrase in a text document is said to be “responsive to a free text query” if the words or portions of words in the text are recognizably related to the free text query. For example, a document that mentions “bibliography” is responsive to a query for the string “bib” because “bib” is a commonly used abbreviation for “bibliography”. Similarly, a document that mentions “car” is responsive to a query containing the string “cars”.

An “annotation” is a piece of descriptive information associated with a media object. For example, a hand-written note in the margin of a book is an annotation. When refering to maps, an annotation is a label that identifies a region or object and describes it with text or other forms of media, such as an image or sound. Map annotation is important to location-related searching, because the search results can be used as annotation on a map.

A “physical domain” is a region of space in the known universe or a class of regions in the known universe. For example, the disk-shaped region between the Earth's orbit and the Sun is a region of space in the known universe that changes in time as our solar system moves with the Milky Way Galaxy. For another example, space inside of a particular model of car are a class of region; any copy of the car has an instance of that class of physical domain.

A “planetary body” is a physical domain of reasonably solid character following a trajectory through the known universe, such as the planet Earth, the planet Mars, the Earth's Moon, the moons of other planets, and also asteroids, comets, stars, and condensing clouds of dust.

A “ranked list” is a sequence of items that has been given an ordering according to a scoring function that provides a score for each item in the list. Typically, the scoring is higher for items earlier in the list. A search result list is such a list, and a relevance function is typically the type of scoring function used to order the list. Each item in the ranked list has a “rank” which is an integer indicating the position in the list. If several items have the same score, then a secondary scoring function may be required to order that subset, or they maybe assigned the same rank or an arbitrary sequence of adjacent ranks.

A “relevance function” is an algorithm, heuristic, procedure, or operation that takes a set of search criteria as input and can then compute a score for any media object. In principle, once initialized with search criteria, a relevance function could be asked to generate a score for any media object. Many media objects may be given a zero-valued score or a null score. Such media objects are called “non-relevant.”

A media object is said to “satisfy” a set of search criteria if there exists a relevance function that provides a score other than non-relevant for that media object.

“AJAX” stands for Asynchronous Javascript and XML. DHTML stands for Dynamic HyperText Markup Language. DHTML and AJAX are widely used on the public Web and in private intranets that host web servers. Developers can write DHTML or AJAX documents in textual form so that web servers can send that text to web browser clients that request it from the server. These DHTML/AJAX pages run procedures and functions in the user's web browser. These procedures are written in the javascript programming language. Essentially all modern web browsers are able to interpret and execute javascript. These procedures and functions allow the visual display presented to the human user to include complex visual effects and rapid updating of information from the server. AJAX procedures are widely used to get information from a server without requiring the browser to reload an entire page. Instead of reloading the entire page, the javascript code running in the page causes the browser to retrieve only the needed information from the server. Then, the javascript code inserts that new information into the page so the user can see. This “asynchronous” loading has enabled a new generation of applications on the Web.

A “mapping client” is a piece of software that displays maps. Mapping clients are also called geographic information systems (GIS). Popular mapping clients include ESRI's ArcMap, globe viewers such as Google Earth, and AJAX mapping tools such as OpenLayers. Several AJAX mapping tools are available to knowledge workers in enterprises and on the public Internet. In addition to such AJAX mapping tools, GIS software systems allow other ways of looking at maps. All of these mapping clients provide backdrop maps on which GTS search results can be displayed.

A “GTS Client Plugin” is a software component that allows users to retrieve and display GTS results on top of a particular mapping client. For example, MetaCarta has built a GTS Client Plugin for ESRI's ArcMap. It is a software program that installs on top of ArcMap and provides a user interface that accepts search criteria from users, the search criteria including free text queries from the user and a domain identifier identifying a domain of interest to the user. The GTS Client Plugin displays visual indicators that represent document-locations that are responsive to the query. MetaCarta has built extensions to several mapping clients that allow users to view GTS results on the mapping client.

An “illustrative” query is a set of search criteria that may have been generated by a user or multiple users at some point in the past and is now used as an example query that suggests to users what an interesting query might look like. Illustrative queries help new users get started using a location-related search engine, and they help experienced users go deeper into the information available. For example, in a location-related search engine providing information to forestry experts, one might see an illustrative query including the free text query “larch seedlings” and a map zoomed into forests in Vermont as the domain identifier. By showing a user results for this illustrative query, the system might attract the users interest to Vermont as an interesting place to explore using the system or to seedlings of the Larch species as an interesting topic. After seeing these results, a novice user has a better idea of what kind of information the system can provide.

### DESCRIPTION OF DRAWINGS

In the Drawing:

FIG. 1 schematically shows an overall arrangement of a computer system according to some embodiments of the invention.

FIG. 2 schematically represents an arrangement of controls on a map interface according to some embodiments of the invention.

FIG. 3 is a schematic of steps in a method of displaying search results based on spatial scaling rules according to some embodiments of the invention.

FIG. 4 schematically represents elements of a map interface for displaying search results based on spatial scaling rules according to some embodiments of the invention.

FIG. 5 is a schematic of steps in a method for presenting potentially interesting search results to a user upon an initiation request according to some embodiments of the invention.

FIG. 6 is a schematic of steps in a method for presenting search results to a user in different modes based on whether the search results come from a single document or multiple documents according to some embodiments of the invention.

FIG. 7 is a schematic of steps in a method for obtaining geographic search results by sampling subdomains within a domain identified by a user query according to some embodiments of the invention.

### DETAILED DESCRIPTION

Overview

The systems and methods described herein provide enhanced ways of presenting information to users. The systems and methods can be used in concert with a geographic text search (GTS) engine, such as that described in U.S. Pat. No. 7,117,199. However, in general the systems and methods are not limited to use with GTS systems, or even to use with search engines.

We present several means of improving GTS systems and the GUIs that they support. These improvements allow users to see more information quickly by making most efficient use of screen space to present appropriate information to users.

First, a brief overview of an exemplary GTS system, and a GUI running thereon, will be described. Then, the different subsystems and methods will be described in greater detail, in separate sections following the overview. Some embodiments will include only one or some of the subsystems or methods.

Many of the embodiments described herein assume that a geographic text search (GTS) engine has generated a list of search results in response to a user query. For example, U.S. Pat. No. 7,117,199 describes exemplary systems and methods that enable the user, among other things, to pose a query to a geographic text search (GTS) engine via a map interface and/or a free-text query. The query results returned by the geographic text search engine are represented on a map interface as icons. The map and the icons are responsive to further user actions, including changes to the scope of the map, changes to the terms of the query, or closer examination of a subset of results.

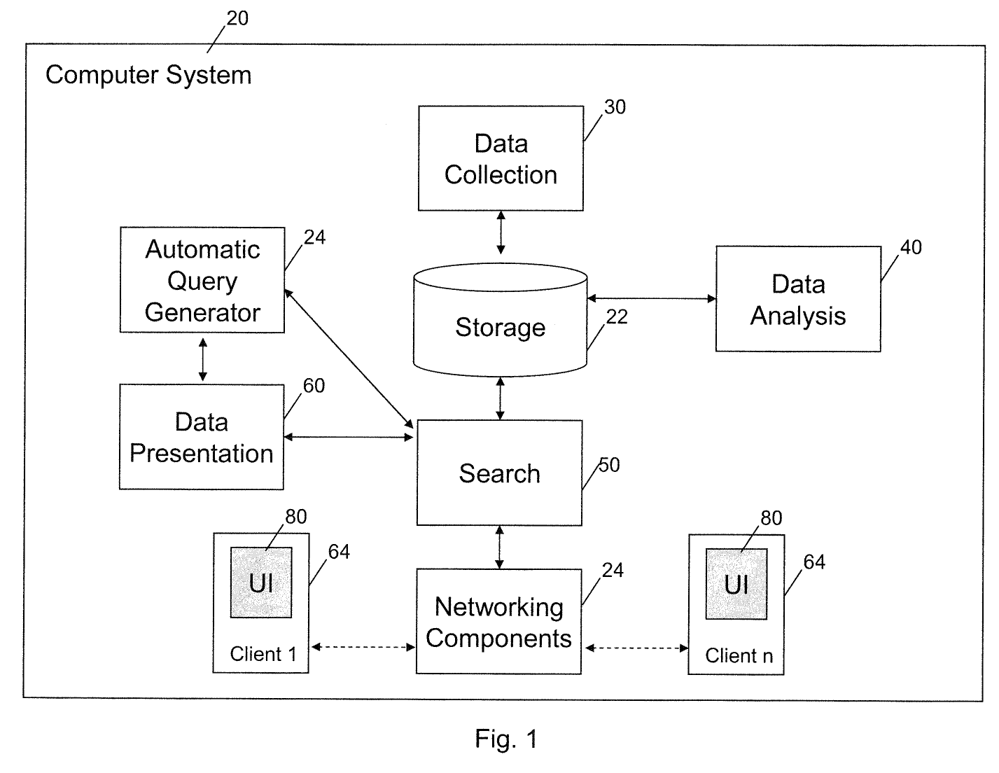

In general, with reference to FIG. 1, the computer system 20 includes a storage 22 system which contains information in the form of documents, along with location-related information about the documents. The computer system 20 also includes subsystems for data collection 30, automatic data analysis 40, manual data analysis 24, search 50, data presentation 60, and results analysis engine 66. The computer system 20 further includes networking components 24 that allow a user interface 80 to be presented to a user through a client 64 (there can be many of these, so that many users can access the system), which allows the user to execute searches of documents in storage 22, and represents the query results arranged on a map, in addition to other information provided by one or more other subsystems, as described in greater detail below. The system can also include other subsystems not shown in FIG. 1.

The data collection 30 subsystem gathers new documents, as described in U.S. Pat. No. 7,117,199. The data collection 30 subsystem includes a crawler, a page queue, and a metasearcher. Briefly, the crawler loads a document over a network, saves it to storage 22, and scans it for hyperlinks. By repeatedly following these hyperlinks, much of a networked system of documents can be discovered and saved to storage 22. The page queue stores document addresses in a database table. The metasearcher performs additional crawling functions. Not all embodiments need include all aspects of data collection subsystem 30. For example, if the corpus of documents to be the target of user queries is saved locally or remotely in storage 22, then data collection subsystem need not include the crawler since the documents need not be discovered but are rather simply provided to the system.

The data analysis 40 subsystem extracts information and meta-information from documents. As described in U.S. Pat. No. 7,117,199, the data analysis 40 subsystem includes, among other things, a spatial recognizer and a spatial coder. As new documents are saved into storage 22, the spatial recognizer opens each document and scans the content, searching for patterns that resemble parts of spatial identifiers, i.e., that appear to include information about locations. One exemplary pattern is a street address. The spatial recognizer then parses the text of the candidate spatial data, compares it to known spatial data, and assigns relevance score to the document. Some documents can have multiple spatial references, in which case reference is treated separately. The spatial coder then associates domain locations with various identifiers in the document content. The spatial coder can also deduce a spatial relevance for terms (words and phrases) that correspond to geographic locations but are not recorded by any existing geocoding services, e.g., infer that the “big apple” frequently refers to New York City. The identified location-related content associated with a document may in some circumstances be referred to as a “GeoTag.” Documents and location-related information identified within the documents are saved in storage 22 as “document-location tuples,” which are two-item sets of information containing a reference to a document (also known as an “address” for the document) and a metadata that includes a domain identifier identifying a location, as well as other associated metadata such as coordinates of the location.

The search 50 subsystem responds to queries with a set of documents ranked by relevance. The set of documents satisfy both the free-text query and the spatial criteria submitted by the user (more below).

The data presentation 60 subsystem manages the presentation of information to the user as the user issues queries or uses other tools on UI 80. For example, given the potentially vast amount of information, document ranking is very important. Results relevant to the user's query must not be overwhelmed by irrelevant results, or the system will be effectively useless to the user. As described in greater detail below, the data presentation 60 subsystem can organize search results based on Cartographic Results Rules, e.g., according to relative scaling of the location referenced in the document and the scaling of the map, in order to allow the user to more readily find results of particular interest than if the results were instead simply presented in a “flat” list as is conventionally done. This functionality can also be provided by logic within the user interface, or by other logic.

The data presentation 60 subsystem can also switch between different presentation modes based on whether the search results include multiple documents, or only a single document. As described in greater detail below, when search results include multiple documents, typically the amount of information the subsystem 60 presents about each document is relatively limited, e.g., the subsystem will present only a “snippet” of relevant text from each document, so that the user can quickly skim the results and identify particularly relevant documents. When search results include only a single document, which may have multiple location references, the data presentation 60 subsystem can switch to a “single document mode” in which it presents more information about the document than it would normally present if the results had included multiple documents. For example, instead of presenting “snippets” of a relatively short fixed length, the subsystem 60 can present longer sections of the document. Some sections can include multiple location references, which would have been presented as separate “results” and thus in separate “snippets” were the subsystem instead presenting the results in a “multiple document mode.”

The system also optionally includes an automatic query generator subsystem 24, which presents the user with potentially interesting search results when the user places an initialization request with the system, e.g., when the user accesses the search system main website page but before the user executes a query. The results can be presented on a “summarizing welcome page,” described in more detail below. The potentially interesting search results can be obtained, for example, by analyzing queries that previous users have performed, and executing a query that appears particularly popular at the moment.

The system also optionally includes an additional “gridding” subcomponent that resides either in client 64 or in search subsystem 50, and is described in greater detail below. The gridding subcomponent can in some circumstances allow the system to more uniformly obtain results within the domain identified by the query, by using a grid to divide the domain into a plurality of subdomains. The gridding subcomponent executes a search for each subdomain, thus effectively “sampling” the entire domain. This can be useful, for example, in cases where one particular subdomain (e.g., New York City) generates a large number of results relative to the identified domain (e.g., a bounding box covering all of the United States, Canada, the Caribbean, and more). Without a gridding subsystem, the first 100 search results might mainly be documents referring to New York City, and the user might not be presented with as many results referring to other locations in the identified domain as might have been useful to him. Since the total number of results that meet a user's query criteria is typically quite large, the system must limit the number that are returned. As with most search engines, an exemplary GTS will use a relevance ranking function to order the results. A limited number of the results at the top of the list are displayed to the user. This can be confusing to users if the limited number of results implies to the user that no results exist for a region. In fact, there may be results that match the user's query criteria but are of lower relevance. Gridding solves this problem by sampling the domain uniformly. By breaking the domain into subdomains and executing a search within each subdomain, it is more likely that the results will not be dominated by documents referring to one or more particularly popular location reference, but rather will represent a sampling of documents referring to a variety of location references. A generic search system might be configured to display the top 100 most relevant results. When gridding is used in a GTS, the configuration is more complicated. The gridding pattern must be specified, and then the maximum number of results for each grid cell must be specified. For example, if a rectangular grid is used, then the number of grid cells is the number of rows times the number of columns used in the gridding pattern. For example, a three-by-five grid has fifteen cells. If each cell is allowed to contribute five results to the final result list, then the total number of results could be as high as seventy-five. Even if one of the grid cells covers an area with a large number of high relevance results, that cell cannot dominate the combined result list. Each other grid cell is still allowed to contribute up to five.

To help the user understand that some of the results are of different levels of relevance, we use visual indicators that encode the relevance levels visually. For example, we use transparency to indicate relevance: higher relevance document-location tuples are indicated by more opaque markers, and lower relevance by more transparent markers, for example as described in U.S. patent application Ser. No. 11/818,066, filed Jun. 12, 2007 and entitled “Systems and Methods for Hierarchical Organization and Presentation of Geographic Search Results,” the entire contents of which are incorporated herein by reference.

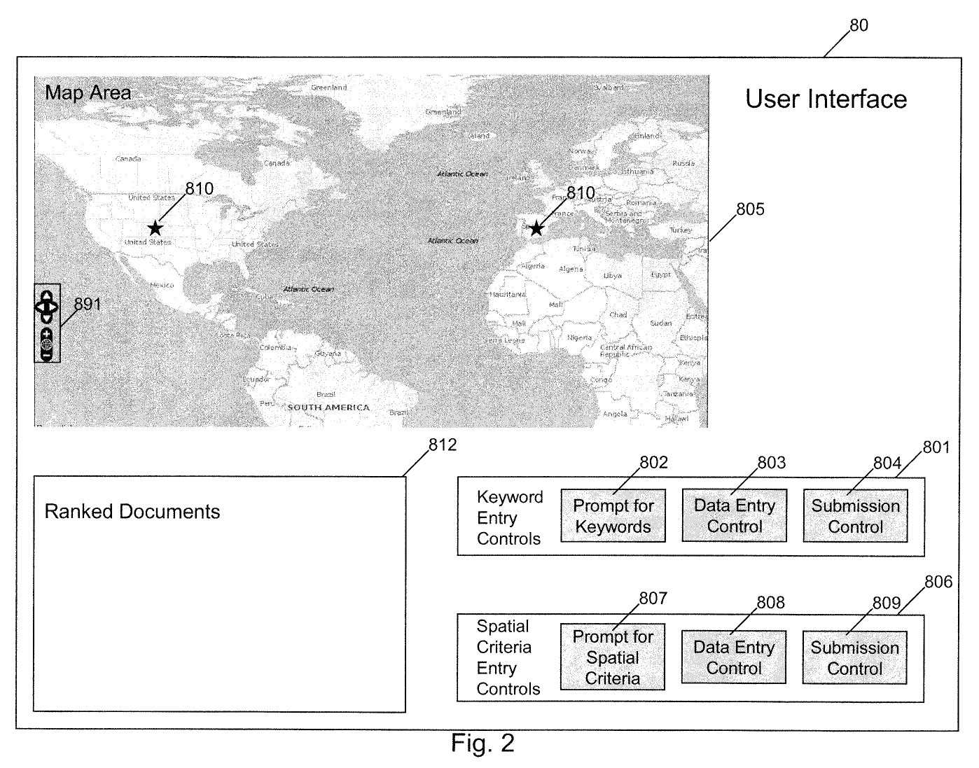

With reference to FIG. 2, the user interface (UI) 80 is presented to the user on a computing device having an appropriate output device. The UI 80 includes multiple regions for presenting different kinds of information to the user, and accepting different kinds of input from the user. Among other things, the UI 80 includes a keyword entry control area 801, an optional spatial criteria entry control area 806, a map area 805, and a document area 812.

As is common in the art, the UI 80 includes a pointer symbol responsive to the user's manipulation and “clicking” of a pointing device such as a mouse, and is superimposed on the UI 80 contents. In combination with the keyboard, the user can interact with different features of the UI in order to, for example, execute searches, inspect results, or correct results, as described in greater detail below.

Map 805 represents a spatial domain, but need not be a physical domain as noted above in the “Definitions” section. The map 805 uses a scale in representing the domain. The scale indicates what subset of the domain will be displayed in the map 805. The user can adjust the view displayed by the map 805 in several ways, for example by clicking on the view bar 891 to adjust the scale or pan the view of the map.

As described in U.S. Pat. No. 7,117,199, keyword entry control area 801 and spatial criteria control area 806 allow the user to execute queries based on free text strings as well as spatial domain identifiers (e.g., geographical domains of particular interest to the user). Keyword entry control area 801 includes area prompting the user for keyword entry 802, data entry control 803, and submission control 804. Optional spatial criteria entry control area 806 includes area prompting the user for keyword entry 802, data entry control 803, and submission control 804. The user can also use map 805 as a way of entering spatial criteria by zooming and/or panning to a domain of particular interest, i.e., the extent of the map 805 is also a form of domain identifier. This information can be transmitted as a bounding box defining the extreme values of coordinates displayed in the map, such as minimum latitude and longitude and maximum latitude and longitude.

Examples of keywords include any word of interest to the user, or simply a string pattern. This “free text entry query” allows much more versatile searching than searching by predetermined categories. The computer system 20 attempts to match the query text against text found in all documents in the corpus, and to match the spatial criteria against locations associated with those documents.

After the user has submitted a query, the map interface 80 may use visual indicators 810 to represent documents in storage 22 that satisfy the query criteria to a degree determined by the search 50 process. The display placement of a visual indicator 810 (e.g., an icon) represents a correlation between its documents and the corresponding domain location. Specifically, for a given visual indicator 810 having a domain location, and for each document associated with the visual indicator 810, the subsystem for data analysis 20 must have determined that the document relates to the domain location. The subsystem for data analysis 20 might determine such a relation from a user's inputting that location for the document. Note that a document can relate to more than one domain location, and thus can be represented by more than one visual indicator 810. Conversely, a given visual indicator can represent many documents that refer to the indicated location. When referring to search results from such a system, we often speak of document-location pairs or tuples.

If present, the document area 812 displays a list of documents or document summaries or portions of documents to the user.

Cartographic Results Rules for Scale-Based Display of Geographic Search Results

When presenting geographic search results generated from a query applied to a document corpus, there are generally many locations to display to the user. Individual documents often refer to multiple locations of different types, and any query that retrieves multiple document-location tuples is likely to have multiple locations to present to the user. One document might refer to a landmark like the Statue of Liberty, New York Harbor, the country of France, the country of the United States, and also a town in Wisconsin. Displaying all of these locations, or “georeferences,” associated with the documents can be complicated.

When presenting geographic search results, for example as generated using the systems and methods described in U.S. Pat. No. 7,117,199 and related applications, it can be useful to represent one or more of the results as point locations in a map, even for references to locations that cover many pixels in the display. Any document-location tuple can be reduced to a document-point tuple by choosing some representative point to indicate the extended region. This allows the document-location tuples to be displayed simply as point objects on the map.

The base maps on which the GTS results are displayed are typically generated through a complex cartographic process in which human editors choose which geographic features to display and by what visual symbols. To do this, cartographers develop careful guides and rules for making these decisions. For example, a particularly difficult task in cartography is deciding what geographic information to not display at low scales. Low-scale maps represent more ground area with the same map area than high-scale maps, which are more “zoomed in.”

While a very high-scale map might look like a life-size photo or even a magnified image showing microscopic features, this type of realism must be reduced in a low-scale display. A high-scale map of a town might cover a 10 cm by 10 cm area of computer screen or paper. A low-scale map depicting the same geographic area of the town would display the town in a smaller area, such as 5 cm by 5 cm of computer screen or paper. In order to squeeze the town into a smaller picture, the cartographer must choose what aspects of the town not to include. The bigger picture of the town naturally includes more information. The process of dropping information to produce a lower-scale map is called “cartographic generalization.”

Mapmakers codify cartographic generalization rules and procedures for deciding which information to drop. For example, one rule might be to stop display roads smaller than a certain width when the scale is lower than a given threshold. Another rule might aggregate precise depictions of mountains and hills into jagged lines that merely conjure the notion of mountains. Usually, cartographic generalization rules eliminate small geographic features to create low-scale depictions. Subjective choices made by the maker of a particular map tend to skew the map's appearance toward particular purposes or communication goals.

These subjective aspects of cartography affect cartographic generalization and choice of visual display elements. Cartographers often choose a theme for a map, and organize their artistic and geometrical choices around that theme. For example, instead of presenting detailed graphics and labels of the world's mountains, a mapmaker might choose to present detailed flow lines and annotations about the currents in the world's oceans. These choices can be codified into thematic rules. For example, if the displaying a label for a mountain and a nearby ocean would collide, the mapmaker could make a rule that the ocean label always got preference and the mountain label would not be displayed. This rule might not matter at high-scales where more map area is available for the same physical area, but at low-scales the labels might have to cover a large amount of physical ground in order to remain legible. Thus, at low-scales this thematic rule would come into effect and skew the presentation toward oceans. Such a rule is both thematic and a cartographic generalization rule.

Another thematic rule might color towns with less than 100,000 people with a purple line around their official perimeter, and towns with between 100,001 and 500,000 people with a yellow perimeter. Another thematic rule might put an icon that looks like an oil well on top of facilities related to oil drilling, and a pipeline icon on top of pipeline-related facilities. These visual rules codify the intentions of the mapmaker, so that the decisions are consistent and efficiently repeated across large map areas.

An important guide in constructing cartographic rules is the principle of “geographic invariance,” which states that cartographic choices should not appear to change the underlying physical reality. For example, a generalization rule that causes mountains to appear to change location is not geographically invariant. Cartographers often intervene when rules breach the geographic invariance principle. Maps of lower than one-to-one scale inevitably breach the principle in some way. It is the cartographer's job is to choose the least egregious or least problematic variations from reality.

Cartographic rules can often be implemented in software. Geographic information systems, such as ESRI's ArcView help people implement and use such rules to make maps. Often, the mapmaker's job is to audit the output of the software driven cartographic rules to make sure they do not violate geographic invariance any more than necessary. This auditing process often leads to new cartographic rules to handle special cases or adjust for particular situations.

For example, some conventional software tools for making digital maps or sets of hardcopy maps allow the cartographer to set attributes on geographic features that determine the range of scales over which the feature will be displayed. The range of scales over which the feature is displayed are typically chosen to make the feature appear when the user is viewing a map that would dedicate a reasonable number of pixels to the feature, and make it disappear when the number of pixels would be small. The number of pixels will be small when viewing a relatively low scale map. When zoomed out far enough, the feature will be contained in less than a pixel. On the other hand, when zoomed in far enough the feature will cover the entire display and may not have any distinguishing differences from pixel to pixel. To cope with this, mapping tools allow cartographers to choose display parameters such as “minimum scale” and “maximum scale,” or minscale and maxscale for short. If a geometric object's minscale attribute is 1:50,000 and maxscale attribute is 1:1,000, then the object will not be displayed unless the map has been zoomed into a scale larger than 1:50,000 but less than 1:1,000.

When displaying GTS results generated from a query applied to a document corpus, as described in U.S. Pat. No. 7,117,199, the various geometric features referenced by the text can be given display attributes such as minscale and maxscale. These attributes can determine whether a result is presented to a user, when the user is viewing a map zoomed to a particular scale. For example, if the location component of one of the document-location tuples in a search result listing from a GTS is a location with a maxscale attribute of 1:100,000, then when the user zooms into a map with a larger scale (e.g. 1:50,000) then this document-location tuple would be removed from the list and not represented in the map by a visual indicator. The minscale/maxscale parameters of each location are set by the GTS geographic data set. It is possible for cartographers to update the parameters for the data set inside the GTS and for data that they add to the GTS for recognizing new location references.

Displaying GTS results on top of a base map creates a new map. However, this new map has not had the full benefit of cartographic editorial control, and thus may not be as meaningful to the user as it could be. Instead of careful human artistry and craftsmanship considering the selection, placement, and appropriateness of each marker at each scale, these new visual elements are added to the map by an automatic software process responding to the user's search input. Many modern mapping tools plot markers on top of maps, and instead of carefully heeding the mapmakers' intentions, the markers just get blotched down on top of the map. The markers fail to become “part” of the map. Many maps, especially on the Web, simply display a scatter of red dots, which as become pejoratively known as “red dot fever.”

Here we disclose systems and methods that organize GTS results based on Cartographic Results Rules (CRR) in order to present the results more meaningfully to the user, and to give the user more control over what is presented in the map. Point-like visual indicators, polygons, or any other suitable markers are used to represent the organized search results.

The systems and methods heed the intentions of different mapmakers by allowing people managing the geographic search engine to define cartographic rules for adding GTS results to various maps. Often, these cartographic rules can be adapted from cartographic rules used to build static maps. As discussed above, GTS results are generally anchored to a particular geographic entity by a georeference in a document, such as a building referred to by its name or a town referred to by its name or a natural feature referred to by its name or type. For example, a document might refer to the building called the “Sears Tower” or the “mountains of New England.” The geographic entity might be simply a point, or it might be a natural feature such as a river or mountain, or a manmade feature such as a building or town. Cartographic rules have been applied to such entities in mapmaking for many years. We carry these cartographic rules a step further by applying them to GTS results. We call these “Cartographic Result Rules” or CRR.

GTS results are typically displayed in two places: as markers and labels annotating a visual map and in a list alongside the map, for example as shown in FIG. 2. Cartographic results rules can affect both of these differently. For example, a CRR might stipulate that GTS results associated with a feature that has been dropped in the process of generalizing the map to a lower scale should only appear in the list and not be represented by markers in the map. A refinement of this CRR might say that the marker only appears in the map when the user indicates interest in that GTS result by placing the pointer on top of the list item for that result. Another rule might say that results associated with features covering less geographic area than a particular threshold are not displayed when the map scale is below a corresponding threshold. Sometimes it is useful to have the opposite CRR, i.e. do not display features larger than a particular size when lower than a particular scale.

CRRs can also be useful when crafting a GTS display for a particular type of user or thematic purpose. For example, a CRR might cause documents from a particular source to appear with different icons that represent that site. For example, if a collection of documents includes documents from both news wires and an internal document repository, there might be a CRR that selects different icons to represent document-location tuples from the two sources. The news wires' icon might show a scrolled piece of paper with black text, and the internal repository's icon might show a canister with a key symbol.

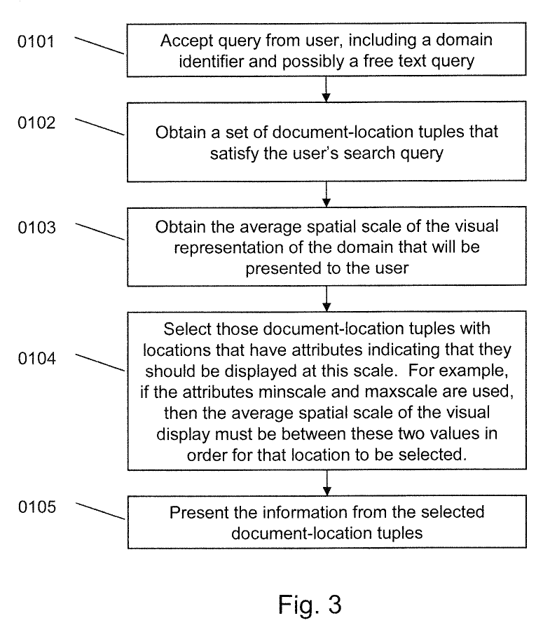

FIG. 3 is a flow chart of a method for accepting a query from a user and deciding which search results to display based on a scale-based CRR, which determines whether a result will be displayed based on whether its display attributes select the average spatial scale of the map displayed. While the illustrated embodiment uses spatial scaling rules to display search results, other rules can be used. The method is described from the point of view of the interface program that presents results to the user.

First, to display search results based on CRRs, the interface program accepts a query 0101 from a user. The user's query can include a free-text string, such as might be submitted through a FORM field in an HTML page, e.g., element 803 in FIG. 1, and/or a domain identifier, e.g., element 808 in FIG. 1, or a bounding box for a map view displayed to a user. If absent, the free-text string is treated as the empty string. If absent, the domain identifier is treated as the whole space, such as the entire planet Earth. The interface program then obtains a set of document-location tuples that satisfy the user's search query 102, e.g., by sending the user's query to a GTS search engine, which generates and returns to the interface program a list of relevance-sorted document-location tuples and associated metadata. Each document-location tuple is implemented as a docID and a locID number that refer to a master database of documents and locations known to the system.

Based on the returned document-location tuples, the interface program then obtains the average spatial scale of the visual representation of the domain that will be presented to the user 0103. The search engine can do this based on information obtained by the client. For example, the client can indicate to the server the width and height of the map image being presented to the user, and also the width and height of the region of space being represented by the map image. Each given pixel in the map represents a particular amount of space. The ratio of the pixel's area on the user's display to the area of the space being depicted is the scale for that pixel. The scale can vary over the image, so the average scale value is computed by summing the scale over all the pixels and dividing by the number of pixels.

Then, the interface program selects those document-location tuples with locations that have attributes (e.g., metadata) indicating that they should be displayed at the average spatial scale 0104. For example, one CRR may state that if the document-location tuple has the attributes of minscale and maxscale, then the average spatial scale of the visual display must be between these two values in order for that document-location tuple to be selected. The interface program then displays information associated with the selected document-location tuples 0105.

Note that steps 102-104 could alternately be performed by the search subsystem before returning the search results to the data presentation subsystem. In some implementations, the search and data presentation subsystems are so closely coupled that they can effectively be considered a single subsystem, with the functionalities both of performing searches based on user queries and selecting and displaying the results to the user.

In general, the number of GTS results that satisfy the user's query can be much larger than the system can practically transmit, or that the user can practically assess. One way of reducing the number of results presented to the user is by ranking the results by a relevance score and sending only a limited number of highest relevance results. Before displaying these results to a user, the system can apply CRRs to attributes of the document-location tuples. These CRRs can cause particular locations to not be displayed, or to be displayed differently. If the CRRs disable the display of some results, the system may attempt to expand the result set by obtaining more document-location tuples of lower relevance from the index, applying the CRRs to those, and displaying any additional results satisfying the CRRs to the user. In embodiments where the interface program applies the CRRs, the interface program can, after applying the CRRs to the first round of search results, execute an additional query to the search engine and obtain additional results to analyze. In embodiments where the search engine applies the CRRs, the search engine can perform additional queries before sending a complete result set, scaled to the map interface, to the interface program.

When a user's query is running over and over again in a notification system, new documents appear in the GTS display automatically. When a document comes from a news wire service and mentions the location of a business, a thematic CRR might say to display an icon representative of a newspaper on the location and to display a text extract from the article in a popup window next to the icon for thirty seconds. An exemplary rule might say that after thirty seconds, send the text to a list of results on the side.

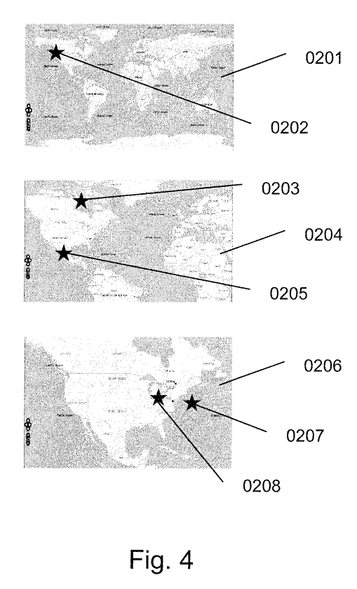

FIG. 4 shows three different maps that a user might see as he changes the scale in the map area 805 of the user interface (referring to FIG. 1). All three maps cover approximately the same amount of space on the visual display of the page, but each represents a different amount of space on the physical Earth (in this case, the metric vector space being displayed is latitude/longitude space parameterizing the physical Earth). Map 0201 is the lowest scale, because it represents the most area. Map 0204 represents less area and is thus higher scale than map 0201. Map 0206 represents less area and is thus higher scale than map 0204. At the lowest scale, location 0202 is an example location that has a maximum scale large enough to be displayed on map 0201. At the next highest scale, location 0202 has disappeared, because its maximum scale value is smaller than the scale of the map 0204. Two more results have appeared, locations 0203 and 0205, which have min/max scale ranges that contain the scale of map 0204. Zooming in further, to the highest scale map 0206, the previous two sets of results (0203 and 0205) have disappeared and now two more results have appeared, locations 0207 and 0208, because map 0206's average scale falls within their min/max scale ranges. Even though all five of the locations (0202, 0203, 0205, 0207, 0208) were contained or overlapped by the domain being represented by each of the three maps (0201, 0204, 0206), the locations did not all appear on the same map. They only appeared on the maps permitted by their scale ranges.

Thus, CRRs are useful because they remove results associated with locations that a person managing the system has decided are “not appropriate” to display at the scale chosen by the user. For example, a person managing the system may decide that for a group of geologists studying several diverse topics, including plate tectonics and gold mine reclamation, it is appropriate only to show locations related to plate tectonics at low scales and only show locations related to gold mine reclamation at high scales. The reason for such a decision might be that tectonic plates are very large objects, so users studying them usually view maps of large areas. In contrast, gold mines are comparatively small, so users studying them usually use the same size display device to view maps of smaller areas. Since the display area is the same size, but the depicted space is much smaller, the scale is much higher. Thus, different scale ranges will be more likely to be viewed by different types of users with different interests. By associating locations of interest to different users with scale ranges likely to be viewed by those users, CRRs make it more likely that each group of users will see what they are interested in seeing without being bothered by information that is less interesting to them.

As a more commonplace example, consider restaurant and food reviews. When a person is looking at a map of all of Europe, it might be more useful to present an overview of food reviews for each country, rather than clutter the map with reviews of individual restaurants. Then, if the user zooms to a higher scale (e.g., selecting a city within one of the countries), the CRRs can determine that results associated with individual restaurant locations will appear.

The hierarchical search results described in earlier filings, e.g., U.S. patent application Ser. No. 11/427,165 filed Jun. 28, 2006, entitled “User Interface for Geographic Search,” the entire contents of which are incorporated herein by reference, have a CRR implicit in them. By not displaying documents that only refer to parent nodes of the currently selected subtree, it makes a cartographic choice about what to include in the map it is making.

Summarizing Welcome Pages Displayed Upon Initialization of a Geographic Search Engine

Users can become confused when first encountering GTS Client Plugins and other user interfaces displaying GTS results, e.g., web pages displaying an interface to a GTS engine. Even people with experience interacting with GTS results can have trouble figuring out what content is available in a particular system. To assist users in understanding the information available from a particular GTS, the system can display an “introduction” interface, also known as a “Summarizing Welcome Page” (SWP). The SWP presents several numbers and visual images that describe the content available in the system and how users can access that content. It functions as a tutorial for new users and as a dashboard for experienced users.

The SWP can be implemented in a couple ways. It can be a full-page display that covers the entire user interface application window, or it can be a pane that only covers part of the browser window.

Among other things, the SWP can present names of document collections available from the various GTS servers that can be searched. It can present the number of documents available in such collections. It can present a map image showing marks on representative locations referenced in that collection. See U.S. Pat. No. 7,117,199 for some embodiments of collaborative behavior that can be displayed on a user interface to a GTS engine.

The SWP can also be used to display of one or more example queries that show actual GTS results that a user could obtain by entering a particular query. This is done upon initialization of the GTS engine (e.g., when the user first accesses the user interface to the engine, such as by visiting the GTS engine homepage). This can both help the user understand the interface, and can also present potentially interesting information to the user, without the need for the user to first execute his own search using a keyword and/or domain identifier. While it is possible for an editor or other human curator to hardcode into the interface a particular example query that they believe represents a potentially interesting set of data, it can useful to have an automatic system that generates interesting queries. This can be particularly useful, because queries that users might consider “interesting” can change. An automatic system can use statistical methods to determine what is currently interesting and generate different information as peoples' behaviors change.

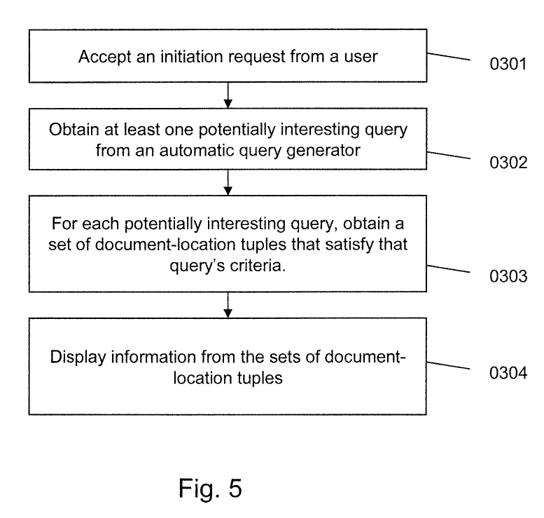

FIG. 5 is a flow chart of steps in a method for presenting potentially interesting search results to a user upon an initialization request. The method is written from the interface program (client) point of view. First, the interface program accepts an initialization request from a user 0301. The user may have accessed the interface program previously, but this is the first request to access the program for the current session, e.g., the user is not currently using the website to interface with the GTS engine. It is useful to draw a distinction between an initialization request to a search engine interface and to any other kind of web page or user interface: the difference is that when initializing a search engine user interface, the system provides means for the user to issue a search request. That is, the user interface generated by the system in response to the initialization request includes input mechanisms, such as form fields, map displays, hierarchy navigation elements, and other means of accepting user input that specific search criteria. Our system provides a GTS user interface, which includes means of accepting search criteria from the user, the search criteria including a free-text query and a domain identifier specifying a domain as filters for finding documents that are responsive to the free-text query and refer to a location in the domain. This enhancement to the system reacts to initialization requests by displaying information from automatically generated query in this same display that offers means of accepting search criteria. In response, the interface program initializes as normal (e.g., provides a map interface and/or domain entry toolbar for the user to enter a domain identifier, and a text box for the user to enter a free text query). The interface program also obtains at least one potentially interesting query from the ACG 0302, for example using one of the criteria described below. Then, for each obtained query, the interface program obtains a set of potentially interesting search results 0303, using the protocols described above and described in greater detail in U.S. Pat. No. 7,117,199. The interface program then displays information from the set of search results 0304, e.g., displays the document-location tuples that satisfy the obtained query. The user can then investigate the set of potentially interesting search results and/or execute his own query.

To generate queries that are presented upon initialization of the GTS engine, and that are potentially interesting to the user, the automatic query generator (AQG) subsystem (element 24 in FIG. 1) can analyze a variety of different data sets, for example:

1. The queries input by users, which include both free-text query strings and also domain identifiers.

2. The document-location tuples retrieving by such queries.

3. The documents and locations that users select for viewing.

4. The documents made available to the GTS.

A simple way for the AQG to generate potentially interesting queries is analyze the set of words and phrases input by users as free text queries and to compute the number of times each word or phrase appears. Those words and phrases that appeared most frequently in the recent past can be considered the most “interesting” for the present time period. To calibrate, the system can use two different time frames to obtain a “background” and “current” frequency of words. For example, a system receiving 100,000 queries every day might maintain a count of the number of times each word and phrase appeared in the last 30 days, and also a similar count for the last 2 days. The longer period would provide approximately three million queries and functions as a background count. To obtain frequencies, the system divides the counts by the total number of queries for that period. The frequencies obtained in the most recent 2 days can then be compared to the background frequencies. Queries that suddenly increase in frequency are more likely to be interesting to users at that moment.

Similarly, the AQG can maintain frequency counts of geographic or other vector space regions viewed by users, and regions that suddenly receive many more queries are considered more “interesting.” A particular way of implementing frequency counts of searches in a multi-dimensional continuous vector space is as follows: divide the space into a regular mesh (e.g., grid) of small cells. For Earth, one might use a two-dimensional vector space to parameterize the space (unprojected latitude-longitude using a WGS84 datum is a common tool for this), and the AQG might maintain a list of half-degree-by-half-degree grid cells. Since a half-degree is 30 miles on the equator or along a line of constant longitude, such a grid cell is typically about a thousand square miles and smaller near the poles. For every domain identifier input by a user as part of query, the AQG increments a counter for every grid cell contained or partially overlapped by that user's query. The counts recorded for these grid cells can be treated exactly as the words and phrases are treated above. The frequency counts for grid cells over the most recent, say, two days can be compared to the most recent, say, thirty days. Grid cells that suddenly increase in frequency are more likely to be potentially “interesting” to users at that moment.

The AQG can apply similar statistical methods to the documents that users retrieve via their queries, or to the documents that users choose to view by clicking hyperlinks presented in the result sets, or to the documents made available to the system to index for users to search. Statistically interesting phrases can be extracted from any of these collections of documents, and the statistically interesting phrases can be used as free text queries shown to users in the SWP. For example, if users have recently retrieved documents that mention “international kit flyers” more frequently that documents retrieved by users in a previous period, then the AQG can provide a query for “international kit flyers” and a domain identifier for the whole metric vector space or a for a subdomain to the SWP, so that the SWP can present these results to users before they ever enter a query.

Generally, an SWP is initiated when a user first activates a GTS Client Plugin or other system displaying GTS results. For example, a browser-based GTS Client Plugin or other web site that displays GTS results can initiate an SWP when a user hits the browser re-load button or enters the base URL (e.g., homepage) for the site into the browser. After a user enters the base URL into their browser, the browser requests the web page associated with that URL, and the web server provides HTML and possibly JavaScript code to the browser. The browser uses this provided data to render a visual display to the user. Since the URL entered by the user typically does not contain any information about the user's interests, the system typically cannot display search results generated by the user until the user takes a second action. Such a second action is typically submitting a free text query and/or a domain identifier by interacting with the visual display rendered by the browser using the data initially provided by the web server.

The SWP changes this process by allowing the data initially provided by the server to show the user the results of queries that the AQG has determined are potentially interesting to the user. The visual display rendered by the browser contains GTS results that are likely to be potentially interesting to the user.

Users can then input queries of their own, or modify the query initially provided by the system. This can get the user started on both reviewing and searching interesting information quickly, and also gives the user a sense of what to expect from the system.

Even after exploring several results of their own initiation, users may request the SWP again because they want to see what new things have become “interesting.”

“Single Document” and “Multiple Document” Display Modes in Interface Program

Although many of the embodiments described herein and in the incorporated patent references assume that a user's search returns multiple document-location tuples, sometimes a search retrieves a single document, which may itself refer to multiple locations. Thus there can be multiple document-location tuples associated with a single document. The interface program, e.g., GTS Client Plugin, can be configured to offer two different modes of displaying information to a user, a “multiple document mode” and a “single document mode,” each mode configured to provide the user with information believed to be the most informative for the type of search results obtained (e.g., multiple results, or single results, respectively).

In the “multiple document” mode, the search results are typically presented in an itemized or enumerated listing of document summaries and metadata. For example, each displayed search result typically includes a title or name of the document, a way to access the document (e.g., a hyperlink or URL), and possibly one or more substrings of text extracted from the document, optionally in addition to a marker on a map interface showing the user the location the document refers to. The pieces of extracted text, also referred to as “extract text” or “snippets,” allow the user to understand some aspects of the document's content without needing to open the document itself. Typically, the extract texts provided to the user are relatively short, e.g., having 60-100 characters. The extract texts allow the user to visually skim several results by viewing a single screen. That is, users often do not scroll down.

However, as noted above, a single document may be associated with multiple locations. Conversely, a single location may be associated with multiple documents. A simple way of displaying search results is to treat each tuple as though it were independent of all other tuples. Thus, in a “multiple document” mode, multiple tuples associated with a given document (or location) might be listed separately, even though they have the document (or location) in common.

A “single document” mode can be used when the search results consist of one or more document-location tuples, and all of the tuples refer to the same document. In this situation, the “single document” mode can improve the user's ability to obtain information about that document, by changing the way the information is presented relative to the way that it would typically be presented in the “multiple document” mode. Instead of displaying separate document-location tuples as though they were independent, the available screen space can be configured to provide more information about how the tuples relate to each other and to the document. For example, by listing the document title and hyperlink once, and by not using whitespace to separate list items, more of the display area can be used to communicate information to the user. This additional space can then be used to expand the extract texts, e.g., to show more characters from the document than would normally be shown in “multiple document” mode. If the location references in the document are close enough together, it is possible for extract texts from two different document-location tuples to overlap. By showing all of the text between the two location references, the display allows the user to better understand the relationship between the two locations. This would typically not be implemented in a display that lists the various document-location tuples for a single document separately.

A “multiple single-document” mode can also be used to display results to a user. This approach groups document-location tuples for a single document together, so that the user can see the location information for that one document in a contiguous block of display area. By listing several such contiguous blocks for different documents, the user can potentially get a deeper understanding of each document. This approach uses larger blocks of contiguous screen area for each document than for the “multiple document” mode, which treats each document-location tuple separately.

When a user's query generates a result set in which all of the document-location tuples are associated with the same document, it can be useful to automatically switch the interface program into “single document” mode. If the user's query generates a result set in which the document-location tuples are from a relatively small number of documents (e.g., 2-5), then it can be automatically switched to “multiple single-document” mode.

In one embodiment, a GTS Client Plugin is used to provide the user interface, and is capable of switching among the different display modes. The GTS Client Plugin can be configured to do this automatically whenever a search retrieves document-location tuples having specific characteristics, such as those described above.

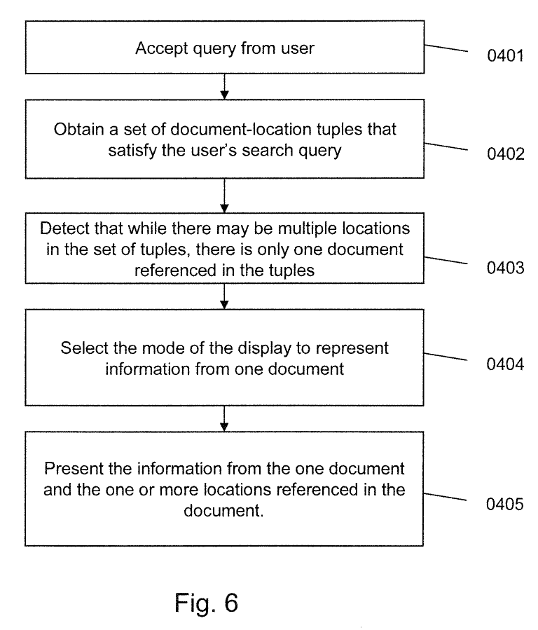

FIG. 6 is a schematic of steps in a method for presenting search results to a user in different modes based on whether the search results come from a single document or multiple documents. The method is written from the point of view of the interface program (client).

First, the interface program accepts a query from a user 0401, e.g., a domain identifier and a free-text query, as described above and elsewhere. The program then obtains a set of document-location tuples that satisfy the query 0402.

Next, the program analyzes the obtained set of tuples, e.g., detects the relationship between the locations and documents within the tuples 0403. For example, the program may compare the docIDs of the tuples. If the program detects that there is one document referenced in the tuples, which may have multiple location references, then the program changes its display mode to “single document” 0404 as described in greater detail above. Then the program presents information about the document and the locations referenced in the document 0405.

Note that while the method is described with reference to the interface program analyzing the set of document-location tuples and selecting display modes accordingly, much of the functionality could also be provided by the GTS engine. For example, the engine could analyze the search results and instruct the interface program to select the appropriate mode accordingly.

Gridding GTS Queries to More Uniformly Sample a Domain

A sampling process is any process that sweeps a system across a range of input values to obtain example output values with finer granularity than would be obtained by considering an output generated by only one input value. Sampling is performed in many systems coping with large volumes of information. For example, many audio systems repeatedly gather information from an audio sensor in order to save information sufficient for reconstruct the sounds detected by the sensor. While such systems generally cannot save information about the sounds at every instant of time that passes, the designers of such systems endeavor to sample the sensor's output as many times per second as possible. The resulting stream of samples can reconstruct an approximation of the sound. The faster the system can record samples, the higher the fidelity of the reconstruction.

Querying a corpus of documents is a type of sampling. Since the user cannot digest all of the documents, search engines provide a sampling of the documents. GTS queries are similar to audio sampling in a specific way: a theoretically ideal system would display visual indicators for every location referenced in the corpus of documents. Technical limitations, such as network speed and client memory constraints, and also the willingness of users to read massive result sets prevent such perfect fidelity. GTS displays must compromise by showing only a sample of the results. Here, we teach that an approximately uniform sampling is better than a non-inform sampling. We teach a particular method of approximately uniform sampling, which we call “gridded queries.”

Many mapping systems use pre-tiled images. Instead of generating images in the fly from the original map data, a tiled map server holds a large number of images that have been generated in a batch process. When a client displays a map, it requests a set of separate images files from the server. The client then displays the images adjacent to each other, so the user sees a seamless visual image of the map. This can be faster than generating a single complete image every time a user requests a particular view.

We have found another use for the concept of tiling: when displaying a set of search results generated from a GTS, it is useful to “grid the request,” that is, break the search request into separate subextents that cover the full extent requested by the user. Each of these geographic extents is sent to the database engine in a separate query, and the results from all these queries are merged together. The request can be broken into subrequests on the server or in the mapping client communicating with the server. Whichever system generates the subrequests must merge the resulting multiple query responses into a single result set that gets displayed to the user.

If the request is broken apart and results merged in the client, then the client must send multiple requests across the network for the separate subqueries. Alternatively, the client may send a single request to the server demanding that it break the request into a grid, such as an N-by-M grid.

An N-by-M grid is an array of rectangles that is N wide and M high. This is an efficient way to divide a domain identified by a rectangular domain identifier, such as a bounding box.

The value of tiling GTS results is interesting: since GTS results are sorted by relevance, it is possible for a single location to “swamp” a request for a single extent. Swamping occurs when there are so many documents referring to a single location, that the beginning of the list of results is all or mostly document-location tuples with that one location. When displayed in the map, this generates a single marker or just a few markers. The display only has one visual representation to display for the location referenced by many documents. This can feel like a sparse data set, because the user only sees this one location indicated. On the other hand, if the client were to display many more documents, at some depth into the list of possible results, other locations might occur in the result set. Unfortunately, this might be so deep in the result set, that the client would have to filter through a very large set of results before it reached results with different locations.

Even if the client could handle a very large set of results, the number of results might be so large that they cannot be transmitted to the client in a timely fashion.

Thus, it is useful to grid the query. By gridding the query, the system ensures that if results exist anywhere in the list of document-location tuples for every grid cell, then they appear. Even if a particular document-location tuples located within one of the grid cells has lower relevance than a large number of document-location tuples in other grid cells, it will still be displayed if it relevance sufficiently high to be one of the best hits within its grid cell.

By requesting separate extents, the system samples the full area requested by the user and is able to show the best hits in several subdomains of the domain identified by the user. This makes a more informative and nuanced visual display for the user. For example, it allows the user to see which areas have documents that are somewhat lower relevance than the would-be-swamper-location and are worth exploring in detail.

A gridded query request to a GTS engine generally includes a specification of the number of gridding rows and cells (N by M grid) and a specification of the maximum number of document-location tuples to return for each grid cell (maxrefs). The total number of results returned is then constrained to be less then or equal to N times M times maxrefs.

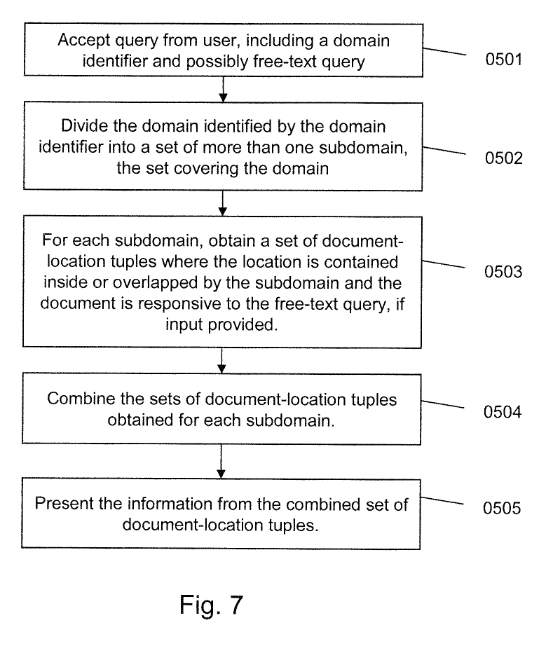

FIG. 7 illustrates steps in a method of generating a spatially uniform set of GTS results, from the point of view of the interface program (client). First, the program accepts a query from a user, e.g., a domain identifier and/or free-text query 0501. Next, the program divides the domain identified by the domain identifier into a set of multiple subdomains, where the set of subdomains covers the domain 0502.

Then, instead of issuing a single query to the GTS engine based on the free-text query and the domain identifier, the program issues a plurality of queries, one for each subdomain. For each subdomain, the program obtains a set of document-location tuples, where the location is contained within or overlapped by the subdomain, and the document is responsive to the free-text query, if one was provided 0503. The program then combines the obtained sets of document-location tuples from the different subdomains 0504, and then presents the user with the combined set of document-location tuples.

The process of gridding could be alternately be performed on the server hosting the GTS engine or some intermediate process.

A number of embodiments of the invention have been described. Nevertheless, it will be understood that various modifications may be made without departing from the spirit and scope of the invention. Accordingly, other embodiments are within the scope of the following claims.

What is claimed is:

1. An interface program stored on a computer-readable medium for causing a computer system with a display device to perform the functions of:
accepting search criteria from a user, the search criteria including a free-text query and a domain identifier, the domain identifier identifying a domain in a metric vector space;
in response to accepting the search criteria from the user, obtaining a set of document-location tuples from a corpus of documents, each document-location tuple satisfying the search criteria from the user, each location having associated cartographic display attributes;
displaying on the display device a visual representation of the domain identified by the domain identifier, the visual representation of the domain having an average spatial scale;
selecting a subset of the set of document-location tuples based on the cartographic display attributes and on the average spatial scale of the visual representation of the domain; and
displaying a plurality of visual indicators representing the selected subset of document-location tuples.

2. The interface program of claim 1, wherein the cartographic display attributes comprise a definition of a minimum average spatial scale and a definition of a maximum average spatial scale.

3. The interface program of claim 2, wherein the program further causes the computer system to perform the functions of selecting a subset of the set of document-location tuples based on whether the average spatial scale of the visual representation of the domain is between the minimum average spatial scale and the maximum average spatial scale.

4. The interface program of claim 3, wherein the program further causes the computer system to perform the functions of accepting user input changing the average spatial scale of the visual representation of the domain, and in response selecting a different subset of the set of document-location tuples based on the cartographic display attributes and on the changed average spatial scale of the visual representation of the domain.

5. The interface program of claim 3, wherein the program further causes the computer system to perform the functions of displaying the documents associated with the set of document-location tuples in a list.

6. The interface program of claim 1, wherein the cartographic display attributes comprise information based on a source of the document-location tuple.

7. A method of displaying information about document-location tuples, the method comprising:
accepting search criteria from a user, the search criteria including a free-text query and a domain identifier, the domain identifier identifying a domain in a metric vector space;
in response to accepting the search criteria from the user, obtaining a set of document-location tuples from a corpus of documents, each document-location tuple satisfying the search criteria from the user, each location having associated cartographic display attributes;
displaying a visual representation of the domain identified by the domain identifier, the visual representation of the domain having an average spatial scale;
selecting a subset of the set of document-location tuples based on the cartographic display attributes and on the average spatial scale of the visual representation of the domain; and
displaying a plurality of visual indicators representing the selected subset of document-location tuples.

8. The method of claim 7, wherein the cartographic display attributes comprise a definition of a minimum average spatial scale and a definition of a maximum average spatial scale.

9. The method of claim 8, further comprising selecting a subset of the set of document-location tuples based on whether the average spatial scale of the visual representation of the domain is between the minimum average spatial scale and the maximum average spatial scale.

10. The method of claim 9, further comprising accepting user input changing the average spatial scale of the visual representation of the domain, and in response selecting a different subset of the set of document-location tuples based on the cartographic display attributes and on the changed average spatial scale of the visual representation of the domain.

11. The method of claim 9, further comprising displaying the documents associated with the set of document-location tuples in a list.

12. The method of claim 7, wherein the cartographic display attributes comprise information based on a source of the document-location tuple.
